(19) United States
(12) Patent Application Publication
(10) Pub. No.: US 2025/0380228 A1
(43) Pub. Date: Dec. 11, 2025

(54) TECHNIQUES FOR INDICATING PARAMETERS ASSOCIATED WITH A SYNCHRONIZATION SIGNAL BLOCK

(71) Applicant: QUALCOMM Incorporated, San Diego, CA (US)

(72) Inventors: Qiaoyu LI, Beijing (CN); Mahmoud TAHERZADEH BOROUJENI, San Diego, CA (US); Tao LUO, San Diego, CA (US); Wooseok NAM, San Diego, CA (US)

(21) Appl. No.: 18/874,314

(22) PCT Filed: Aug. 17, 2022
(86) PCT No.: PCT/CN2022/112952

§ 371 Date: Dec. 12, 2024

(51) Int. Cl. H04W 56/00; H04B 17/373; H04W 16/28

(52) U.S. Cl. CPC H04W 56/0015; H04B 17/373; H04W 16/28

(57) ABSTRACT

Methods, systems, and devices for wireless communications are described for a machine learning (ML) model to predict measurements of synchronization signal blocks (SSBs). A user equipment (UE) may receive an indication of a serving cell configuration information element including a multi-dimensional field indicating a set of multi-dimensional indices associated with a first set of SSBs, where a first dimension of a multi-dimensional index indicates a first beam parameter and a second dimension indicates a second beam parameter. The UE may predict one or more measurements associated with a second set of SSBs based on parameters and measurements of the first set of SSBs. The UE may transmit a message indicating a beam for communications between the UE and a network entity based on the one or more measurements associated with the first set of SSBs and the predicted one or more measurements associated with the second set of SSBs.

### CROSS REFERENCE

The present Application is a 371 national phase filing of International PCT Application No. PCT/CN2022/112952 by LI et al., entitled “TECHNIQUES FOR INDICATING PARAMETERS ASSOCIATED WITH A SYNCHRONIZATION SIGNAL BLOCK,” filed Aug. 17, 2022, which is assigned to the assignee hereof, and which is expressly incorporated by reference in its entirety herein.

### FIELD OF TECHNOLOGY

The following relates to wireless communications, including techniques for indicating parameters associated with a synchronization signal block (SSB).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, communication devices may perform beam management procedures to identify a beam to support communications between the communication devices. In one example of a beam management procedure, a network entity may transmit synchronization signal blocks (SSBs) over a plurality of beams. A UE, or some other receiving device, may receive one or more of the SSBs and measure the one or more SSBs. The UE may then select a beam to support communications between the UE and the network entity based on the measurements.

### SUMMARY

The described techniques relate to improved methods, systems, devices, and apparatuses that enable indicating parameters associated with a synchronization signal block (SSB). For example, the described techniques provide for implementing a machine learning (ML) model, algorithm, etc. to identify measurements of a set of SSBs (e.g., 64 SSBs, 128 SSBs, or more) based on measurements of a subset of (e.g., a portion of a total set of) the SSBs. In some examples, to aid the ML model, the UE may receive an indication of beam information associated with each SSB from the subset of SSBs. For example, the UE may receive a multi-dimensional index for each SSB from the subset of SSBs, where the multi-dimensional index may indicate beam information associated with the corresponding SSB. Accordingly, the UE may identify the beam information associated with the transmitted subset of SSBs based on multi-dimensional indices associated with each SSB of the subset of SSBs. The UE may measure the subset of SSBs, and input the measurements and the beam information determined by the multi-dimensional index for each SSB of the subset into a measurement prediction model (e.g., a ML model, an algorithm). The measurement prediction model may output predicted measurements of the remaining SSBs from the set of SSBs. The UE may select a beam for communications between the UE and a network entity based on the measurements and the predicted measurements for the set of SSBs. The UE may indicate the selected beam to the network entity, and communicate with the network entity using the selected beam.

A method for wireless communications at a user equipment (UE) is described. The method may include receiving an indication of a serving cell configuration information element, the serving cell configuration information element including a multi-dimensional field indicative of a set of multi-dimensional indices associated with a first set of SSBs, where a first dimension of a multi-dimensional index indicates a first beam parameter of an SSB of the first set of SSBs, and where a second dimension of the multi-dimensional index indicates a second beam parameter of the SSB, receiving the first set of SSBs based on the set of multi-dimensional indices, predicting one or more measurements associated with a second set of SSBs based on the first beam parameter, the second beam parameter, and one or more measurements associated with the received first set of SSBs, and transmitting a message indicating a beam for communications between the UE and a network entity based on the one or more measurements associated with the first set of SSBs and the predicted one or more measurements associated with the second set of SSBs.

An apparatus for wireless communications at a UE is described. The apparatus may include a processor, memory coupled with the processor, and instructions stored in the memory. The instructions may be executable by the processor to cause the apparatus to receive an indication of a serving cell configuration information element, the serving cell configuration information element including a multi-dimensional field indicative of a set of multi-dimensional indices associated with a first set of SSBs, where a first dimension of a multi-dimensional index indicates a first beam parameter of an SSB of the first set of SSBs, and where a second dimension of the multi-dimensional index indicates a second beam parameter of the SSB, receive the first set of SSBs based on the set of multi-dimensional indices, predict one or more measurements associated with a second set of SSBs based on the first beam parameter, the second beam parameter, and one or more measurements associated with the received first set of SSBs, and transmit a message indicating a beam for communications between the UE and a network entity based on the one or more measurements associated with the first set of SSBs and the predicted one or more measurements associated with the second set of SSBs.

Another apparatus for wireless communications at a UE is described. The apparatus may include means for receiving an indication of a serving cell configuration information element, the serving cell configuration information element including a multi-dimensional field indicative of a set of multi-dimensional indices associated with a first set of SSBs, where a first dimension of a multi-dimensional index indicates a first beam parameter of an SSB of the first set of SSBs, and where a second dimension of the multi-dimensional index indicates a second beam parameter of the SSB, means for receiving the first set of SSBs based on the set of multi-dimensional indices, means for predicting one or more measurements associated with a second set of SSBs based on the first beam parameter, the second beam parameter, and one or more measurements associated with the received first set of SSBs, and means for transmitting a message indicating a beam for communications between the UE and a network entity based on the one or more measurements associated with the first set of SSBs and the predicted one or more measurements associated with the second set of SSBs.

A non-transitory computer-readable medium storing code for wireless communications at a UE is described. The code may include instructions executable by a processor to receive an indication of a serving cell configuration information element, the serving cell configuration information element including a multi-dimensional field indicative of a set of multi-dimensional indices associated with a first set of SSBs, where a first dimension of a multi-dimensional index indicates a first beam parameter of an SSB of the first set of SSBs, and where a second dimension of the multi-dimensional index indicates a second beam parameter of the SSB, receive the first set of SSBs based on the set of multi-dimensional indices, predict one or more measurements associated with a second set of SSBs based on the first beam parameter, the second beam parameter, and one or more measurements associated with the received first set of SSBs, and transmit a message indicating a beam for communications between the UE and a network entity based on the one or more measurements associated with the first set of SSBs and the predicted one or more measurements associated with the second set of SSBs.

In some examples of the method, apparatuses, and non-transitory computer-readable medium described herein, receiving the indication may include operations, features, means, or instructions for receiving a radio resource control (RRC) message including the serving cell configuration information element.

In some examples of the method, apparatuses, and non-transitory computer-readable medium described herein, receiving the indication may include operations, features, means, or instructions for receiving remaining minimum system information (RMSI) indicating the set of multi-dimensional indices.

In some examples of the method, apparatuses, and non-transitory computer-readable medium described herein, receiving the indication may include operations, features, means, or instructions for receiving other system information (OSI) indicating the set of multi-dimensional indices.

In some examples of the method, apparatuses, and non-transitory computer-readable medium described herein, receiving the indication may include operations, features, means, or instructions for receiving a signal including a first integer associated with the first dimension and a second integer associated with the second dimension of the multi-dimensional index for each SSB of the first set of SSBs.

Some examples of the method, apparatuses, and non-transitory computer-readable medium described herein may further include operations, features, means, or instructions for mapping each SSB of the first set of SSBs to a multi-dimensional index table based on the first integer and the second integer corresponding to each SSB.

In some examples of the method, apparatuses, and non-transitory computer-readable medium described herein, the first integer indicates a column of the multi-dimensional index table and the second integer indicates a row of the multi-dimensional index table.

Some examples of the method, apparatuses, and non-transitory computer-readable medium described herein may further include operations, features, means, or instructions for receiving an indication of a maximum integer associated with the first dimension and a maximum integer associated with the second dimension.

In some examples of the method, apparatuses, and non-transitory computer-readable medium described herein, a maximum integer associated with the first dimension may be predefined and a maximum integer associated with the second dimension may be predefined.

In some examples of the method, apparatuses, and non-transitory computer-readable medium described herein, the first integer may be less than or equal to a maximum integer associated with the first dimension and the second integer may be less than or equal to a maximum integer associated with the second dimension.

In some examples of the method, apparatuses, and non-transitory computer-readable medium described herein, receiving the indication may include operations, features, means, or instructions for receiving a signal including a first integer indicative of a size of the first dimension and a second integer indicative of a size of the second dimension and mapping, sequentially, each SSB of the first set of SSBs to locations of a multi-dimensional index table based on the first integer and the second integer and an order of SSBs of the first set of SSBs.

Some examples of the method, apparatuses, and non-transitory computer-readable medium described herein may further include operations, features, means, or instructions for receiving an indication of an integer range associated with the first dimension and an integer range associated with the second dimension, the first integer being within the integer range associated with the first dimension and the second integer being within the integer range associated with the second dimension, where the integer range associated with the first dimension, the second dimension, or both may be defined by a minimum integer and a maximum integer.

In some examples of the method, apparatuses, and non-transitory computer-readable medium described herein, the first integer defines a number of columns of the multi-dimensional index table and the second integer defines a number of rows of the multi-dimensional index table.

Some examples of the method, apparatuses, and non-transitory computer-readable medium described herein may further include operations, features, means, or instructions for receiving a signal indicating that the first beam parameter may be one of an azimuth beam direction, an elevation beam direction, a beam width, a peak beamforming gain, or an angular specific beamforming gain and that the second beam parameter may be one of the azimuth beam direction, the elevation beam direction, the beam width, the peak beamforming gain, or the angular specific beamforming gain, where the first beam parameter and the second beam parameter may be different.

Some examples of the method, apparatuses, and non-transitory computer-readable medium described herein may further include operations, features, means, or instructions for identifying that the first beam parameter may be one of an azimuth beam direction, an elevation beam direction, a beam width, a peak beamforming gain, or an angular specific beamforming gain based on a preconfiguration of the first beam parameter and identifying that the second beam parameter may be one of the azimuth beam direction, the elevation beam direction, the beam width, the peak beamforming gain, or the angular specific beamforming gain based on a preconfiguration of the second beam parameter, where the first beam parameter and the second beam parameter may be different.

In some examples of the method, apparatuses, and non-transitory computer-readable medium described herein, predicting the one or more measurements may include operations, features, means, or instructions for inputting the first beam parameter, the second beam parameter, and one or more measurements associated with the received first set of SSBs to a beam prediction model and identifying the one or more measurements associated with the second set of SSBs as outputs of the beam prediction model.

In some examples of the method, apparatuses, and non-transitory computer-readable medium described herein, the beam prediction model may be an algorithm, or a machine-learning model.

In some examples of the method, apparatuses, and non-transitory computer-readable medium described herein, a second set of multi-dimensional indices may be associated with a first set of channel state information (CSI) reference signals (CSI-RS), a first dimension of a second multi-dimensional index indicates a first beam parameter of a CSI-RS of the first set of CSI-RSs, and a second dimension of the second multi-dimensional index indicates a second beam parameter of the CSI-RS of the first set of CSI-RSs.

Some examples of the method, apparatuses, and non-transitory computer-readable medium described herein may further include operations, features, means, or instructions for receiving the first set of CSI-RSs based on the second set of multi-dimensional indices, predicting one or more measurements associated with a second set of CSI-RSs based on the first beam parameter of the CSI-RS, the second beam parameter of the CSI-RS, and one or more measurements associated with the received first set of CSI-RSs, and transmitting a second message indicating channel information associated with communications between the UE and the network entity based on the one or more measurements associated with the first set of CSI-RSs and the predicted one or more measurements associated with the second set of CSI-RSs.

A method for wireless communications at a network entity is described. The method may include transmitting an indication of a serving cell configuration information element, the serving cell configuration information element including a multi-dimensional field indicative of a set of multi-dimensional indices associated with a first set of SSBs, where a first dimension of a multi-dimensional index indicates a first beam parameter of an SSB of the first set of SSBs, and where a second dimension of the multi-dimensional index indicates a second beam parameter of the SSB, transmitting the first set of SSBs based on the set of multi-dimensional indices, and receiving a message indicating a beam for communications between a UE and the network entity, where the beam is associated with the first set of SSBs or a second set of SSBs.

An apparatus for wireless communications at a network entity is described. The apparatus may include a processor, memory coupled with the processor, and instructions stored in the memory. The instructions may be executable by the processor to cause the apparatus to transmit an indication of a serving cell configuration information element, the serving cell configuration information element including a multi-dimensional field indicative of a set of multi-dimensional indices associated with a first set of SSBs, where a first dimension of a multi-dimensional index indicates a first beam parameter of an SSB of the first set of SSBs, and where a second dimension of the multi-dimensional index indicates a second beam parameter of the SSB, transmit the first set of SSBs based on the set of multi-dimensional indices, and receive a message indicating a beam for communications between a UE and the network entity, where the beam is associated with the first set of SSBs or a second set of SSBs.

Another apparatus for wireless communications at a network entity is described. The apparatus may include means for transmitting an indication of a serving cell configuration information element, the serving cell configuration information element including a multi-dimensional field indicative of a set of multi-dimensional indices associated with a first set of SSBs, where a first dimension of a multi-dimensional index indicates a first beam parameter of an SSB of the first set of SSBs, and where a second dimension of the multi-dimensional index indicates a second beam parameter of the SSB, means for transmitting the first set of SSBs based on the set of multi-dimensional indices, and means for receiving a message indicating a beam for communications between a UE and the network entity, where the beam is associated with the first set of SSBs or a second set of SSBs.

A non-transitory computer-readable medium storing code for wireless communications at a network entity is described. The code may include instructions executable by a processor to transmit an indication of a serving cell configuration information element, the serving cell configuration information element including a multi-dimensional field indicative of a set of multi-dimensional indices associated with a first set of SSBs, where a first dimension of a multi-dimensional index indicates a first beam parameter of an SSB of the first set of SSBs, and where a second dimension of the multi-dimensional index indicates a second beam parameter of the SSB, transmit the first set of SSBs based on the set of multi-dimensional indices, and receive a message indicating a beam for communications between a UE and the network entity, where the beam is associated with the first set of SSBs or a second set of SSBs.

In some examples of the method, apparatuses, and non-transitory computer-readable medium described herein, transmitting the indication may include operations, features, means, or instructions for transmitting an RRC message including the serving cell configuration information element.

In some examples of the method, apparatuses, and non-transitory computer-readable medium described herein, transmitting the indication may include operations, features, means, or instructions for transmitting RMSI indicating the set of multi-dimensional indices.

In some examples of the method, apparatuses, and non-transitory computer-readable medium described herein, transmitting the indication may include operations, features, means, or instructions for transmitting OSI indicating the set of multi-dimensional indices.

In some examples of the method, apparatuses, and non-transitory computer-readable medium described herein, transmitting the indication may include operations, features, means, or instructions for transmitting a signal including a first integer associated with the first dimension and a second integer associated with the second dimension of the multi-dimensional index for each SSB of the first set of SSBs.

In some examples of the method, apparatuses, and non-transitory computer-readable medium described herein, each SSB of the first set of SSBs may be mappable to a multi-dimensional index table based on the first integer and the second integer corresponding to each SSB.

In some examples of the method, apparatuses, and non-transitory computer-readable medium described herein, the first integer indicates a column of the multi-dimensional index table and the second integer indicates a row of the multi-dimensional index table.

Some examples of the method, apparatuses, and non-transitory computer-readable medium described herein may further include operations, features, means, or instructions for transmitting an indication of a maximum integer associated with the first dimension and a maximum integer associated with the second dimension.

In some examples of the method, apparatuses, and non-transitory computer-readable medium described herein, a maximum integer associated with the first dimension may be predefined and a maximum integer associated with the second dimension may be predefined.

In some examples of the method, apparatuses, and non-transitory computer-readable medium described herein, the first integer may be less than or equal to a maximum integer associated with the first dimension and the second integer may be less than or equal to a maximum integer associated with the second dimension.

In some examples of the method, apparatuses, and non-transitory computer-readable medium described herein, transmitting the indication may include operations, features, means, or instructions for transmitting a signal including a first integer indicative of a size of the first dimension and a second integer indicative of a size of the second dimension, where each SSB of the first set of SSBs may be mappable, sequentially, to locations of a multi-dimensional index table based on the first integer and the second integer and an order of SSBs of the first set of SSBs.

Some examples of the method, apparatuses, and non-transitory computer-readable medium described herein may further include operations, features, means, or instructions for transmitting an indication of an integer range associated with the first dimension and an integer range associated with the second dimension, the first integer being within the integer range associated with the first dimension and the second integer being within the integer range associated with the second dimension, where the integer range associated with the first dimension, the second dimension, or both may be defined by a minimum integer and a maximum integer.

In some examples of the method, apparatuses, and non-transitory computer-readable medium described herein, the first integer defines a number of columns of the multi-dimensional index table and the second integer defines a number of rows of the multi-dimensional index table.

Some examples of the method, apparatuses, and non-transitory computer-readable medium described herein may further include operations, features, means, or instructions for transmitting a signal indicating that the first beam parameter may be one of an azimuth beam direction, an elevation beam direction, a beam width, a peak beamforming gain, or an angular specific beamforming gain and that the second beam parameter may be one of the azimuth beam direction, the elevation beam direction, the beam width, the peak beamforming gain, or the angular specific beamforming gain, where the first beam parameter and the second beam parameter may be different.

In some examples of the method, apparatuses, and non-transitory computer-readable medium described herein, a second set of multi-dimensional indices may be associated with a first set of CSI-RSs, a first dimension of a second multi-dimensional index indicates a first beam parameter of a CSI-RS of the first set of CSI-RSs, and a second dimension of the second multi-dimensional index indicates a second beam parameter of the CSI-RS of the first set of CSI-RSs.

Some examples of the method, apparatuses, and non-transitory computer-readable medium described herein may further include operations, features, means, or instructions for transmitting the first set of CSI-RSs based on the second set of multi-dimensional indices and receiving a message indicating channel information associated with communications between the UE and the network entity, where the channel information may be associated with the first set of CSI-RSs, a second set of CSI-RSs, or both.

### BRIEF DESCRIPTION OF THE DRAWINGS

FIG. 1 illustrates an example of a wireless communications system that supports techniques for indicating parameters associated with a synchronization signal block (SSB) in accordance with one or more aspects of the present disclosure.

FIG. 2 illustrates an example of a wireless communications system that supports techniques for indicating parameters associated with an SSB in accordance with one or more aspects of the present disclosure.

FIG. 3 illustrates an example of a module training process flow that supports techniques for indicating parameters associated with an SSB in accordance with one or more aspects of the present disclosure.

FIG. 4 illustrates an example of communication fields that support techniques for indicating parameters associated with an SSB in accordance with one or more aspects of the present disclosure.

FIGS. 5 and 6 illustrate examples of multi-dimensional index mappings that support techniques for indicating parameters associated with an SSB in accordance with one or more aspects of the present disclosure.

FIG. 7 illustrates an example of a process flow that supports techniques for indicating parameters associated with an SSB in accordance with one or more aspects of the present disclosure.

FIGS. 8 and 9 show block diagrams of devices that support techniques for indicating parameters associated with an SSB in accordance with one or more aspects of the present disclosure.

FIG. 10 shows a block diagram of a communications manager that supports techniques for indicating parameters associated with an SSB in accordance with one or more aspects of the present disclosure.

FIG. 11 shows a diagram of a system including a device that supports techniques for indicating parameters associated with an SSB in accordance with one or more aspects of the present disclosure.

FIGS. 12 and 13 show block diagrams of devices that support techniques for indicating parameters associated with an SSB in accordance with one or more aspects of the present disclosure.

FIG. 14 shows a block diagram of a communications manager that supports techniques for indicating parameters associated with an SSB in accordance with one or more aspects of the present disclosure.

FIG. 15 shows a diagram of a system including a device that supports techniques for indicating parameters associated with an SSB in accordance with one or more aspects of the present disclosure.

FIGS. 16 through 19 show flowcharts illustrating methods that support techniques for indicating parameters associated with an SSB in accordance with one or more aspects of the present disclosure.

### DETAILED DESCRIPTION

In some wireless communications systems, a user equipment (UE) may be configured to monitor for synchronization signal blocks (SSBs) transmitted by a network entity (e.g., network device, base station). The UE may receive the one or more SSBs and measure the one or more SSBs. In some examples, the UE may be configured to monitor for and measure multiple SSBs (e.g., 64 SSBs, 128 SSBs, or more). The UE may use the measurements to select a beam for communications between the UE and network entity and may transmit an indication of the selected beam to the network entity. In some cases, the UE may be configured to measure a number (e.g., quantity, set) of SSBs above a threshold (e.g., a threshold of 64 SSBs), which may lead to increased overhead and latency in selecting a beam.

To reduce overhead and latency, techniques may be implemented to support a machine learning (ML) model, algorithm, etc., to predict measurements of a set of SSBs (e.g., 64 SSBs, 128 SSBs, or more) based on measurements of a subset of (e.g., a Qualcomm Ref. No. 2203860) portion of a total set of) the SSBs. In some cases, to aid the ML model, the UE may receive an indication of beam information associated with one or more SSBs. For example, the UE may receive the beam information for each SSB from the set of SSBs or each SSB from the subset of SSBs, or some combination thereof. The beam information may be indicated to the UE in the form of a multi-dimensional index. For example, each multi-dimensional beam index may indicate a first beam parameter and a second beam parameter associated with a corresponding SSB. The first and second beam parameters may indicate beam shape information such as beam pointing direction, beam width, angular specific beamforming gain, etc.

In some implementations, a parameter (e.g., ServingCellConfigCommon, remaining minimum system information (RMSI), other system information (OSI), etc.) may be used to indicate the multi-dimensional beam indices. The multi-dimensional indices may be indicated explicitly or implicitly to the UE. For example, in accordance with explicit indication, the parameter may include multiple integers indicative of the multi-dimensional indices for each SSB. Implicit indication of the multi-dimensional indices may include an ordering SSBs being indicative of the multi-dimensional index associated with each SSB.

In some examples, the UE may receive an indication of the multi-dimensional indices associated with corresponding SSBs and may receive and measure the subset of SSBs. The UE may input the measurements and the beam shape information (e.g., as determined by the multi-dimensional index) for each SSB of at least the subset into a measurement prediction model (e.g., ML model, algorithm). The measurement prediction model may output predicted measurements of the remaining SSBs from the set of SSBs, thereby reducing the number of SSB measurements that the UE may perform to obtain beam information (e.g., for beam selection, beam refinement, cell selection, or other procedures) for the total set of SSBs. The UE may select a beam from the set of SSBs, transmit an indication of the selected beam to the network entity, and communicate with the network entity using the selected beam.

Particular aspects of the subject matter described herein may be implemented to realize one or more advantages. The described techniques may support improvements in beam management procedures by decreasing signaling overhead, reducing power consumption of the UE, improving reliability, and decreasing latency, among other advantages. As such, supported techniques may include improved network operations and, in some examples, may promote network efficiencies, among other benefits.

Aspects of the disclosure are initially described in the context of wireless communications systems. Aspects of the disclosure are further illustrated and described with reference to a module training process flow, communication fields, multi-dimensional index mappings, and a process flow. Aspects of the disclosure are further illustrated by and described with reference to apparatus diagrams, system diagrams, and flowcharts that relate to techniques for indicating parameters associated with an SSB.

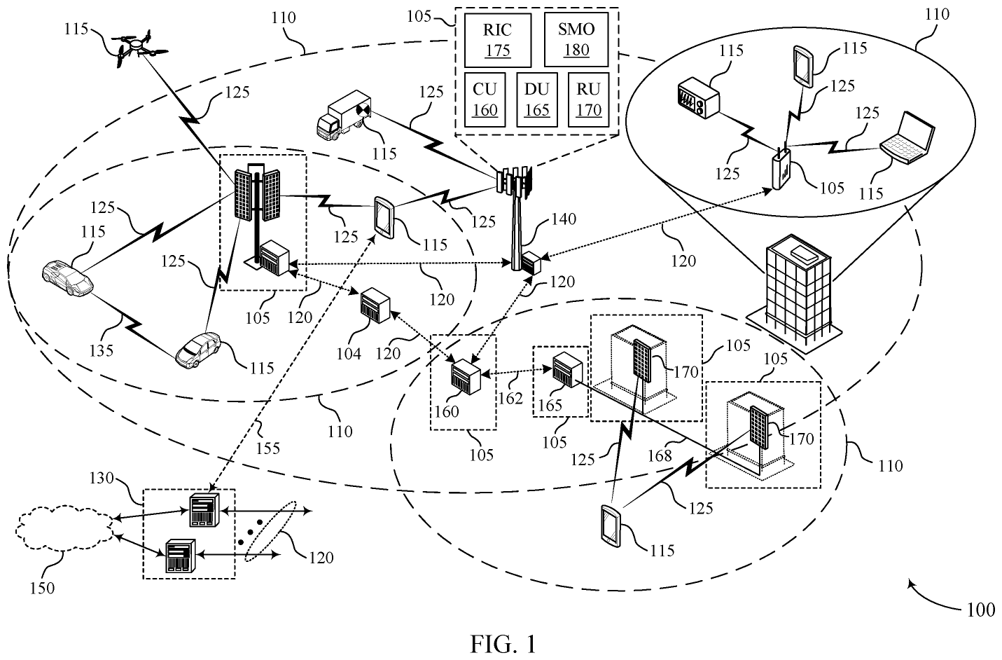

FIG. 1 illustrates an example of a wireless communications system 100 that supports techniques for indicating parameters associated with an SSB in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support techniques for indicating parameters associated with an SSB as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, or FR5, or may be within the EHF band.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., the network entity 105, the UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UE 115 may connect to a network (e.g., network entity 105, gNB) and detect beam failure through beam management procedures. For example, a UE 115 may be in an idle mode (e.g., RRC_IDLE) or in an inactive mode (e.g., RRC_INACTIVE), and may engage in an initial access procedure with the network entity 105. Initial access may include SSB beam sweeping in which SSBs may be transmitted in beams in predefined directions at regular intervals. After the initial access procedure, the UE 115 may engage in beam management in a connected mode (e.g., RRC_CONNECTED). In some cases, the UE 115 may identify beam failure discovery based on measurements and the UE 115 may perform beam failure recovery, in response. In some cases, the UE 115 may perform fast recovery to maintain or re-establish the connected mode. In some examples, the UE 115 may not continue to fast recovery after beam failure discovery. In such cases, the beam failure recovery may lead to radio link failure. For example, the UE 115 may experience blockage of the radio frequency signal, such as if the UE 115 is indoors, and the interruption of communication may result in beam failure. The beam failure recovery may not successfully recover the connection or connect to another beam, such as if the UE 115 continues to experience blockage, which may result in radio link failure.

Beam management may include beam prediction in a time domain, a frequency domain, a spatial domain, or a combination thereof. In beam management, beam qualities and failures may be identified via measurements. In some examples, increasing measurements to measure beam quality or beam failure may increase performance while increasing power consumption and overhead. In an example where there are restrictions on power or overhead, beam accuracy or beam selection accuracy may be correspondingly limited. Beam resuming efforts may impact latency or throughput.

In predictive beam management (e.g., spatial domain, time domain, frequency domain) non-measured beam qualities may be predicted, which may reduce power and overhead and increase accuracy. Predictive beam management may include predicting future beam blockage or failure, which may impact latency and throughput by preventing failures. However, beam prediction may be non-linear and difficult to achieve accurately. Factors of beam prediction may include predicting future transmitting beam qualities that may depend on factors of the UE 115, such as moving speed or trajectory, receiving beams previously used or to be used in the future, interference, etc., of the UE 115. Complicated factors of beam prediction may increase the difficulty of modeling beams via statistical signaling processing methods.

Accordingly, it may be beneficial to utilize artificial intelligence (AI) or ML based methods to perform predictive beam management procedures. Prediction may be performed by the UE 115 or at the network entity 105. The UE 115 may make a tradeoff between performance and power consumption. For example, when predicting downlink qualities or transmitting beam qualities, the UE 115 may perform more observations, or measurements, than the network entity 105 receiving observations through UE feedback, which may lead to increased beam prediction accuracy at the UE 115 compared to prediction accuracy at the network entity 105. However, increased prediction accuracy may result in the UE 115 consuming more power to make inferences. Thus, increasing performance may increase power consumption of the UE 115.

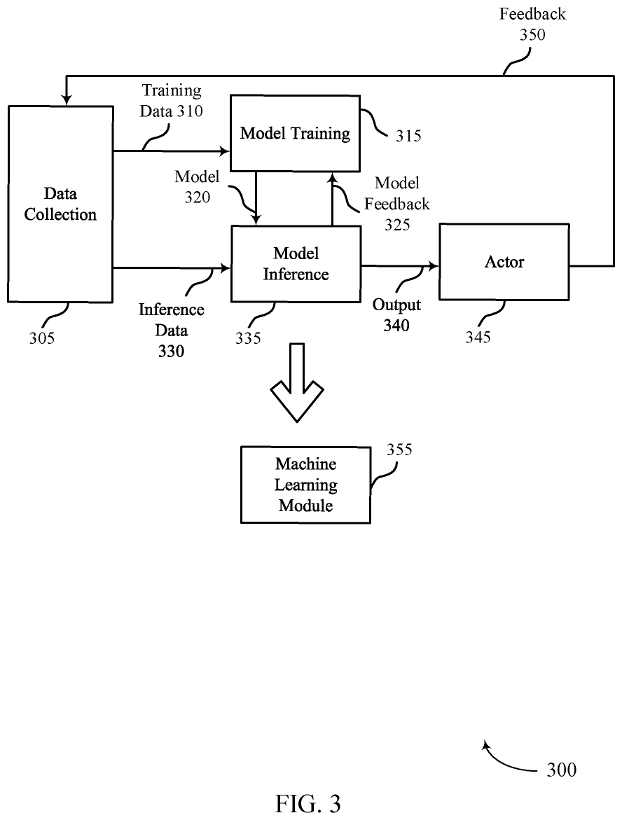

Model training at the network entity 105 or the UE 115 may affect data collection efforts and computations at the UE 115. For example, training at the network entity 105 may include data being collected through enhanced air interface or app-layer approaches. Training at the UE 115 may include additional computation or buffering efforts to train the model and store data. Model training may be described in more detail with reference to FIG. 3.

Beam prediction and selection may be AI/ML based in the spatial domain, time domain, or both. The ML model may use codebook based spatial domain selection, non-codebook based spatial domain prediction, or joint spatial domain and time domain beam prediction. Joint beam prediction may include serving beam refinement, link quality and interference adaptation, beam failure prediction, beam blockage prediction, and radio link failure prediction.

Codebook based spatial domain selection may be provided an input of a first set of beams and output a second set of beams and may utilize compressive beam measurements in the spatial domain and time domain. The compressive beam measurements may be a part of input for a codebook based spatial domain selection, for example. Layer 1 reference signal received power (L1-RSRP) may be measured or reported by the UE 115, and inferences may be experienced by the network entity 105, the UE 115, or both. Inferences associated with the first set of beams may be input into a ML model, and the ML model may output a second set of beams. Codebook based selection may be linked to initial access, secondary cell group (SCG) setup, serving beam refinement, or link quality and interference adaptation.

Non-codebook based spatial domain prediction may be facilitated via raw channel extraction. A channel, beams, or RSRPs may be measured or reported by the UE 115, and inferences may be experienced by the network entity 105, the UE 115, or both based on the channel, beams, or RSRPs. The inferences at the network entity 105, the UE 115, or both associated with the channel or beams may be input into a ML model and the output of the model may be a beam, which may be defined by a point-direction, an angle of arrival (AoA), angle of departure (AoD), etc. Non-codebook based spatial domain prediction and may be linked to serving beam refinement as well as link quality and interference adaptation.

Beam shape indications may be implemented by a location management function (LMF). The LMF may indicate the quantized version of the relative power between positioning reference signal (PRS) resources per angle per transmission/reception point (TRP). Relative power may be defined with respect to the peak power in each angle. For each angle, PRS resources may be reported (e.g., two or more). In some examples, the peak power per angle may not be provided. In some other examples, explicit power per angle per PRS resource indications may be provided. The LMF may provide assistance information for a downlink PRS's beam pointing direction to the UE 115. Examples of assistance information for a downlink PRS's beam pointing direction may include elevation, azimuth with relation to boresight, or based on a global or local coordinate system.

In some cases, beam management procedures may be performed for SCG setup. Accordingly, one or more SSBs may be configured for an SCG setup procedure. An information element (e.g., ServingCellConfigCommon) may indicate or provide dedicated signaling when configuring the UE 115 with an SCG (e.g., an additional cell group). Additional aspects of the information element may be defined. For example, each information element (e.g., ServingCellConfigCommon) may contain an SSB configuration (e.g., ssb-PositionsInBurst) and random-access channel (RACH) configurations (e.g., RACH-ConfigCommon). The SSB configuration (e.g., ssb-PositionsInBurst) may include a bit-map (e.g., with a length of 64 bits), may be applied to a frequency range (e.g., FR2), and may indicate the time domain positions of transmitted SSBs. The RACH configuration (e.g., RACH-ConfigCommon) may include information for initial access, such as a system information block (e.g., SIB1) for initial access procedures.

The IE (e.g., ServingCellConfigCommon) may be applicable in many situations or examples. For example, the UE 115 may have an RRC connection based on a serving cell in a first frequency range (e.g., ServingCell #0 in FR1). The UE 115 may be configured with another serving cell in a second frequency range (e.g., ServingCell #1 in FR2) through the information element (e.g., ServingCellConfigCommon). The UE 115 may measure SSBs in a serving cell (e.g., ServingCell #1) and may perform a RACH procedure for a contention-based random access (CBRA) (e.g., RACH-ConfigCommon for CBRA or RACH-ConfigDedicated for CFRA configured in Serving Cell #1). In some examples, the UE may begin measurements from an initial process (e.g., P1) for beam management (e.g., in FR2) with a number (e.g., quantity, set) of SSBs above a threshold (e.g., a threshold of 64 SSBs).

In some cases, SSB beam shape information may be used by the UE 115. The IE (e.g., ServingCellConfigCommon) may include SSB beam shape information for the UE 115. The UE 115 may use SSB beam shape information to predict L1-RSRPs, where the SSB information may reduce measurement power used by the UE 115 and may reduce latency during SCG setup. Beam shape information may include pointing direction, beam width, or angular specific gains. For example, in a ML model (e.g., a ML model predownloaded from the network entity 105 or implemented by the UE 115), an input may be the L1-RSRPs of SSBs (e.g., 4 SSBs which may be based on the information of the beam shapes), and output may be the L1-RSRPs of the remaining L1-RSRPs. In some implementations, the IE may include cell-common beam shape information, which may have overhead, or parameters the UE 115 may acquire from a system information block when accessing the cell from an idle mode. Cell-common information, such as beam information, may affect coverage and overhead. In some examples, explicitly indicating beam shape information may increase overhead and thus may be inefficient for indicating cell-common information. Re-indexing channel measurement resources (CMRs) in a multi-dimensional manner to indicate spatial neighboring information of CMRs through a channel state information (CSI) report or resource configuration may not be applicable in examples of initial access.

Techniques described herein may implement multi-dimensional indexing (e.g., CMR indexing) for RMSI indication of SSBs, or some other indication, which may reduce overhead. For example, a ML model, algorithm, etc., may predict measurements of a set of SSBs based on measurements of a subset of the SSBs. In some examples, to aid the ML model, the UE 115 may receive an indication of beam information associated with each SSB from the subset of SSBs. For example, the UE 115 may receive a multi-dimensional index for each SSB from the subset of SSBs, where the multi-dimensional index may indicate beam information associated with the corresponding SSB. Accordingly, the UE 115 may identify the beam shape information associated with the transmitted subset of SSBs based on multi-dimensional indices associated with each SSB of the subset of SSBs. The UE 115 may measure the subset of SSBs, and input the measurements and the beam information determined by the multi-dimensional index for each SSB of the subset into the ML model. The ML model may output predicted measurements of the remaining SSBs from the set of SSBs. The UE 115 may select a beam for communications between the UE 115 and the network entity 105 based on the measurements for the set of SSBs. The UE 115 may indicate the selected beam to the network entity 105, and communicate with the network entity 105 using the selected beam. Accordingly, the UE 115 may select a beam from a set of SSBs by performing measurements for a subset of SSBs based on efficient multi-dimensional indices indications associated with the SSBs.

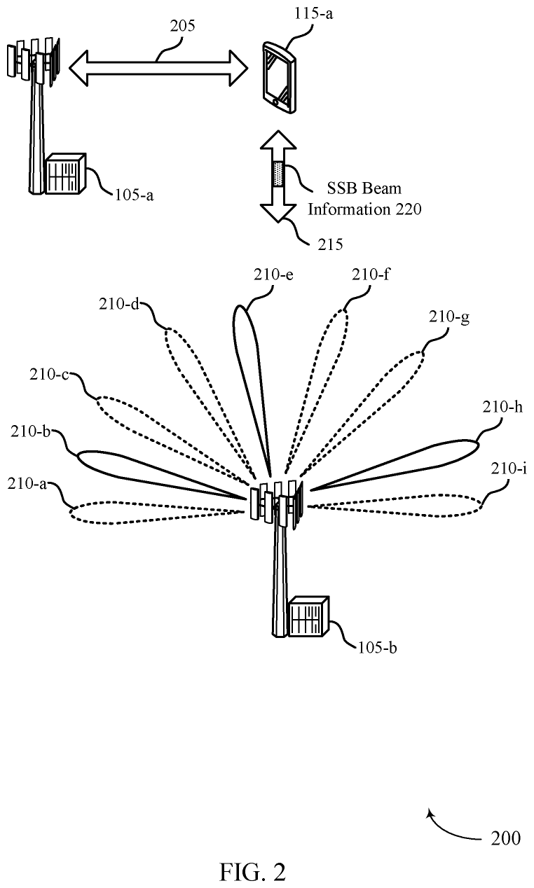

FIG. 2 illustrates an example of a wireless communications system 200 that supports techniques for indicating parameters associated with an SSB in accordance with one or more aspects of the present disclosure. Wireless communications system 200 illustrates the communications between a network entity 105-a or a network entity 105-b with a UE 115-a. The network entity 105-a and the network entity 105-b may be examples of a network entity 105 as described with reference to FIG. 1, and the UE 115-a may be an example of a UE 115 as described with reference to FIG. 1. The UE 115-a may communicate through communication links 205 and 215 (e.g., uplink communication links, downlink communication links).

The UE 115-a may connect to and communicate with the network entity 105-a using the communication link 205. In some cases, the network entity 105-a may be a serving network entity for the UE 115-a (e.g., a master cell group (MCG)). In some cases, the UE 115-a may monitor network entities 105 other than the network entity 105-a. For example, in dual connectivity, a device (e.g., the UE 115, the UE 115-a) may be connected to two cells, or in general, two cell groups, such as the MCG and the SCG. Cell group may be used to refer to a carrier aggregation scenario where there are multiple cells, one per aggregated carrier, in each cell group. The two cell groups may be handled by different network entities 105. Accordingly, the UE 115-a may monitor for SSBs transmitted by one or more non-serving network entities 105 to determine one or more preferred beams to use for communications with the non-serving network entities. In some cases, a non-serving network entity 105 may be referred to as an SCG. For example, the network entity 105-b may be a secondary cell that the UE 115-a may monitor SSBs from.

For example, the UE 115-a may receive the one or more SSBs from the network entity 105-b and measure the one or more SSBs. In some examples, the UE 115-a may be configured to monitor for and measure multiple SSBs. The UE 115-a may use the measurements to select a beam for communications between the UE 115-a and the network entity 105-a and may transmit an indication of the selected beam to the network entity 105-a. In some cases, however, monitoring for a number (e.g., quantity, set) of SSBs above a threshold may lead to increased overhead and latency in selecting a beam.

To reduce overhead and latency, the UE 115-a may be configured to implement a ML model, algorithm, etc., to predict measurements of a set of SSBs based on measurements of a subset of the SSBs. For example, the UE 115-a may receive, via the network entity 105-a, the network entity 105-b, or both, a message (e.g., RRC, MAC-CE, DCI) indicating the UE 115-a to monitor for a subset of SSBs from the network entity 105-b, such as SSBs associated with beams 210-b, 210-e, and 210-h. Accordingly, the UE 115-a may monitor and receive the subset of SSBs via beams 210-b, 210-e, and 210-h. The UE 115-a may then input one or more measurements associated with the subset of SSBs into a measurement prediction model to predict measurements associated with one or more other SSBs, such as SSBs associated with beams 210-a, 210-c, 210-d, 210-f, 210-g, and 210-i.

In some cases, to aid the ML model, the UE 115-a may receive an indication of beam information associated with one or more SSBs (e.g., SSB beam information 220). In some cases, the UE 115-a may receive the beam information for each SSB from the set of SSBs (e.g., beam information for beams 210-a through 210-i), or receive beam information for each SSB from the subset of SSBs (e.g., beam information for beams 210-b, 210-e, and 210-h), or some combination thereof. The beam information may be indicated to the UE 115-a in the form of a multi-dimensional index. For example, each multi-dimensional beam index may indicate a first beam parameter and a second beam parameter associated with a corresponding SSB. The first and second beam parameters may indicate beam shape information such as beam pointing direction, beam width, angular specific beamforming gain, etc., where the first and second beam parameters may indicate different beam information.

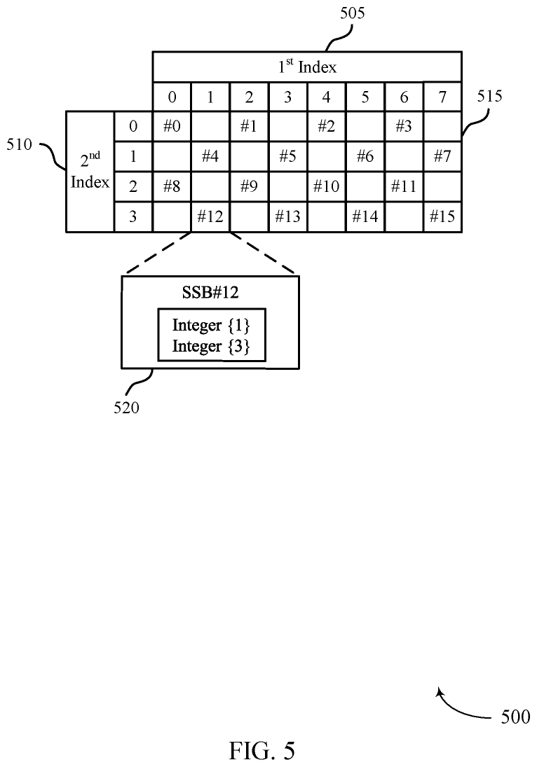

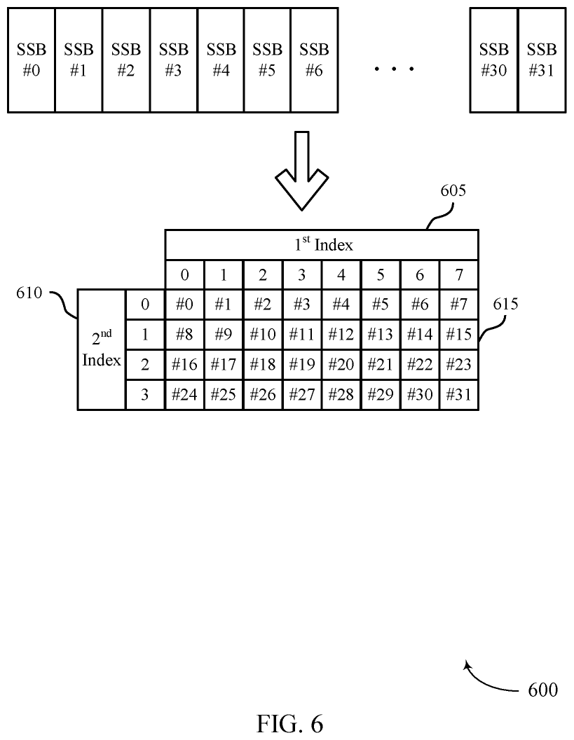

In some cases, the UE 115-a may receive the SSB beam information 220 from the network entity 105-b via communication link 215, or from the network entity 105-a, or both, via RRC signaling, MAC-CE signaling, DCI signaling, etc. In some cases, the UE 115-a may be configured with the SSB beam information 220 via an IE included in RRC (e.g., ServingCellConfigCommon). The IE may indicate the subset of SSBs to be monitored such as via a first field of the IE (e.g., ssb-PositionsInBurst) and the IE may additionally indicate the multi-dimensional indices via a second field of the IE (e.g., MultiDimensionIndices). In some cases, the IE may explicitly or implicitly indicate the multi-dimensional indices as described with reference to FIGS. 5 and 6.

Each multi-dimensional index may include any number of dimensions, where each dimension may indicate a beam parameter. Each dimension may be associated with a different beam parameter (e.g., a definition). The beam parameters may include azimuth beam pointing direction, elevation beam pointing direction, beam width, peak beamforming gain, angular specific beamforming gain, etc. For example, a first dimension may indicate an azimuth direction and a second dimension may indicate elevation beam pointing direction. In another example, a first dimension may indicate beam width, a second dimension may indicate peak beamforming game, and a third dimension may indicate elevation beam pointing direction. The parameters indicated by the dimensions of a multi-dimensional index may be preconfigured, determined by the UE 115-a, determined by the network entity 105-a, or a combination thereof. The definitions of the dimensions may be configured aperiodically, semi-persistently, or dynamically. For example, the UE 115-a may receive a message (e.g., RRC, MAC-CE, DCI), such as from the network entity 105-a, indicating the definition of the multi-dimensional indices.

In some cases, to reduce overhead associated with indicating multi-dimensional indices via a serving cell configuration common information element, different options of the definitions may be configured through a current serving cell (e.g., ServCell such as the MCG in FR1), and a serving cell configuration common information element (e.g., ServingCellConfigCommon associated with SCG) may indicate (e.g., activate) one of the options. For example, a first option may include two dimensions including azimuth and elevation beam pointing directions. A second option may include two dimensions including an azimuth beam pointing direction and beam width. A third option may include three dimensions including azimuth beam pointing direction, beam width, and peak beamforming gain. Accordingly, a network entity (e.g., the network entity 105-a, the network entity 105-b) may select one or the configured options and indicate the selected option via the serving cell configuration common information element. Different options may also include different beam pointing direction differences between adjacent indices, or different beam width ranges with respect to different indices, or different peak beamforming gains with respect to different indices.

Azimuth or elevation beam pointing direction may be defined based on GCS or LCS. The UE 115-a may assume that the adjacent indices include adjacent beam pointing directions, where the adjacent difference can be further based on a preconfiguration or a configuration by the network entity. With reference to beam width, the UE 115-a may assume that the smaller indexed beams include lower beam width (e.g., and vice versa), where the beam width for respective indices may be further based on a preconfiguration or a configuration by the network entity. With reference to peak beamforming gain, the UE 115-a may assume that the smaller indexed beams include stronger beamforming gain, where the relative beamforming gain for respective indices may be based on a preconfiguration or a configuration by the network entity. With reference to angular specific beamforming gain, the indices associated with a certain dimension may correspond to a beamforming gain along a certain angle (e.g., azimuth angle, elevation angle), where which angle is associated with a certain dimension may be based on a preconfiguration or a configuration by the network entity.

Accordingly, the UE 115-a may identify beam shape information associated with the transmitted SSBs based on the multi-dimensional indices. As such, the UE 115-a may measure a subset of SSBs associated with beams 210-b, 210-e, and 210-h. The UE 115-a may then predict a second subset of beams, such as one or more of beams 210-a 210-c, 210-d, 210-f, 210-g, and 210-i by inputting the measurements of the subset of beams and the beam information associated with one or more of the SSBs into a measurement prediction model. Based on the measurements and the beam information, the measurement prediction model may output the measurements for SSBs associated with one or more of beams 210-a 210-c, 210-d, 210-f, 210-g, and 210-i. The UE 115-a may then select a beam from a set of beams that may include the subset measured and the subset predicted. The UE 115-a may then transmit an indication of the selected beam to the network entity 105-a, the network entity 105-b, or both.

In some cases, the techniques described herein may be applied to SSBs for initial access, applied to CSI references signals (CSI-RSs), or both. For example, the multi-dimensional indices information may be identified by the UE 115-a from RMSI or OSI. In another example, the multi-dimensional indices described herein, may be identified by the UE 115-a for UE-specifically configured CSI-RSs. For respective UE-specific configured CSI-RSs, multi-dimensional indices can be identified for the CSI-RSs using techniques described herein. In some cases, different serving cells may determine different definition options predefined or preconfigured by the MCG, while the multi-dimensional indices information with respective to the UE-specific CSI-RS may be configured to follow the option chosen by the associated serving cell.

FIG. 3 illustrates an example of a module training process flow 300 that supports techniques for indicating parameters associated with an SSB in accordance with one or more aspects of the present disclosure. The module training process flow illustrates a procedure for training a ML module 355. In some examples, a UE (e.g., the UE 115 as described with reference to FIGS. 1 and 2), or some other network device (e.g., a network entity 105 as described with reference to FIGS. 1 and 2) may utilize the ML module 355 for the prediction of SSBs.

In some cases, the UE may perform the procedure for training a ML module 355. In some cases, a device other than the UE may perform the training procedure to determine the ML module 355 and the device may configure the UE with the ML module 355. In such cases, the UE may be preconfigured with the ML module 355 or may receive an indication of the ML module 355, or both. The UE, some other device, or both may perform the procedure for training a ML module 355 periodically, aperiodically, or semi-statically. For example, the ML module 355 may be updated over time.

The training procedure may include data collection 305. Data collection 305 may be a function to provide training data 310 to the model training 315 and to provide inference data 330 to the model inference 335 function. In some cases, the training data 310, the inference data, or both, may include SSB measurements, beam information (e.g., beam pointing direction, beam width, angular specific beamforming gain) associated with the SSB measurements, or both. Data collection 305, model training 315, model inference 335, and actor 345 may be functions of processing data. Input data collected in the data collection 305 may include measurements from one or more UEs, measurements from one or more network entities, feedback 350 from the actor 435, or output from an AI/ML model. The training data 310 may be input data for the model training 315 function, and the inference data 330 may be input data for the model inference 335 function.

Model training 315 may be a function to perform ML model training, validation, and testing. The model training 315 may generate model performance metrics, which may be a part of the model testing procedure. Functions of the model training 315 may include data preparation (e.g., data pre-processing, cleaning, formatting, and transformation) based on training data 310. The model 320 may be an output of a model deployment or update. The model 320 may initially deploy a trained, validated, and tested AI/ML model to the model inference 335, or the model 320 may deliver an updated model to the model inference 335. Model feedback 325 may be received by the model training 315 and used to create an updated model 320.

The model inference 335 function may provide output 340 for the actor 345 or model feedback 325 to the model training 315. The output 340 may be a model inference output, such as predictions or decisions, of the AI/ML model. Details of the output 340 may be specific to each model, case (e.g., use case), or implementation. The model inference 335 may determine whether to send model feedback 325 to the model training 315. In some implementations, the model inference 335 function may prepare data (e.g., data pre-processing, cleaning, formatting, and transformation) based on inference data 330 (e.g., inference data delivered by a data collection 305 function).

The model feedback 325 may include model performance feedback. In some cases, model feedback 325 may be sent to the model training 315. Model performance feedback may be applied if information derived from the model inference 335 is suitable for the improvement of the AI/ML model trained in the model training 315. Additional feedback, such as the feedback 350, feedback from the actor 345, or feedback from the data collection 305, may be included as part of the determination of the model feedback 325.

The actor 345 may receive the output 340 from the model inference 335 function and may send feedback 350 to the data collection 305 function. The actor 345 may be a function that receives the output 340 and triggers or performs corresponding actions. For example, the actor 345 may trigger actions directed to other functions or entities, or itself. The feedback 350 may be information used to derive training, inference data, or performance feedback.

The training procedure as described may result in a ML module 355. The training module may configure the ML module 355 to predict measurements of a set of SSBs. For example, the UE may measure one or more SSBs of a set of SSBs and the UE may input the measurements to the ML module 355. In some cases, the UE may input beam information (e.g., beam information determined by the multi-dimensional index) for each SSB of at least the subset into the ML module 355. In some cases, the UE may input multi-dimensional indices associated with the SSBs as the beam information, or the UE may be configured to explicitly input beam parameters associated with the SSBs (e.g., beam parameters indicated by the multi-dimensional indices). The ML module 355 may output predicted measurements of the remaining SSBs from the set of SSBs based on the subset of measurements and beam information. The UE analyze the measured and predicted SSB measurements for the set of SSBs and may select a beam for communications between the UE and the network entity. In some cases, the UE may indicate the selected beam to the network entity, and communicate with the network entity using the selected beam.

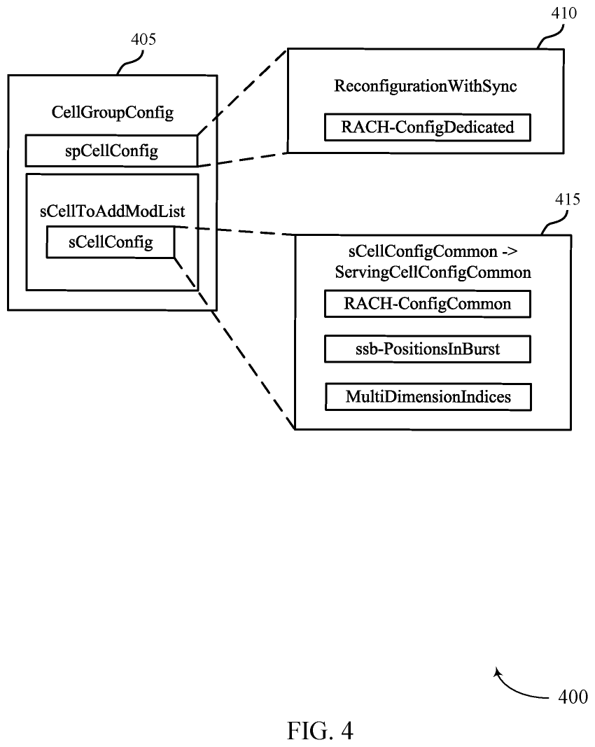

FIG. 4 illustrates an example of communication fields 400 that support techniques for indicating parameters associated with an SSB in accordance with one or more aspects of the present disclosure. The communication fields 400 may be configured to include an indication of multi-dimensional indices indicative of beam information, such as beam information associated with SSBs. The communication fields may include information element 405 that may indicate cell group configuration information (e.g., CellGroupConfig). Information element 405 may include information element 410 and information element 415 that may further indicate configuration information. In some examples, the communication fields 400 may be configured dynamically, semi-statically, aperiodically via RRC, MAC-CE, DCI, etc. In some cases, a UE (e.g., a UE 115 as described with reference to FIG. 1) or some other receiving device, may receive one or more of communication fields 400 from a MCG, a SCG, or both.

In some cases, beam management procedures may be performed for SCG setup. Accordingly, one or more SSBs may be configured for a SCG setup procedure. A serving cell configuration common information element (e.g., ServingCellConfigCommon) may indicate or provide dedicated signaling when configuring the UE with an SCG (e.g., an additional cell group). Additional aspects of the information element may be defined. For example, each serving cell configuration common information element may contain an SSB configuration (e.g., ssb-PositionsInBurst) and random-access channel (RACH) configurations (e.g., RACH-ConfigCommon). The SSB configuration (e.g., ssb-PositionsInBurst) may include bit-map, may be applied to a frequency range (e.g., FR2), and may indicate the time domain positions of transmitted SSBs. The RACH configuration (e.g., RACH-ConfigCommon) may include information for initial access, such as a system information block (e.g., SIB1) for initial access procedures.

The serving cell configuration common IE (e.g., ServingCellConfigCommon) may be applicable in many situations or examples. For example, the UE may have an RRC connection based on a serving cell in a first frequency range (e.g., ServingCell #0 in FR1). The UE may be configured with another serving cell in a second frequency range (e.g., ServingCell #1 in FR2) through the information element (e.g., ServingCellConfigCommon). The UE may measure SSBs in a serving cell (e.g., ServingCell #1) and may perform a RACH procedure for a contention-based random access (CBRA) (e.g., RACH-ConfigCommon for CBRA or RACH-ConfigDedicated for CFRA configured in Serving Cell #1). In some examples, the UE may begin measurements from an initial process (e.g., P1) for beam management (e.g., in FR2) with a number (e.g., quantity, set) of SSBs above a threshold amount of SSB measurements.

In some cases, the UE may receive information element 405, which may include cell group configuration information (e.g., CellGroupConfig). In some cases, information element 405 may include at least a first parameter (e.g., spCellConfig) and a second parameter (e.g., sCellToAdModList). In some cases, the sCellToAddModList may include an sCellConfig information element.

The first parameter (e.g., spCellConfig) may include information element 410 (e.g., ReconfigurationWithSync), which may include an indication of a dedicated RACH configuration for the UE (e.g., RACH-ConfigDedicated).

The second parameter (e.g., sCellToAdModList) included in information element 405 may include information element 415. Information element 415 may indicate common configuration information for a secondary cell (sCell) (e.g., sCellConfigCommon, ServingCellConfigCommon). For example, information element 415 may include a common RACH configuration (e.g., RACH-ConfigCommon). Additionally, the information element may include SSB positions (e.g., ssb-PositionsInBurst). For example, the SSB positions may indicate the SSBs the UE is to monitor, such as the subset of SSBs as described herein (e.g., the SSBs to be received and measured by the UE), or the set of SSBs as described herein (e.g., the SSBs to be predicted by the SSB, the total set of measured and predicted SSBs).

The information element 415 may be configured to include an indication of multi-dimensional indices (e.g., MultiDimensionIndices). The multi-dimensional indices may be associated with one or more of the SSBs identified in ssb-PositionsInBurst and configured by the ServingCellConfigCommon. The multi-dimensional indices included in MultiDimensionIndices may be mapped with one or more of the SSBs identified from the ssb-PositionsInBurst (e.g., identified by the bit value of 1). The UE may thus identify beam shape information associated with the one or more of the SSBs based on the indicated multi-dimensional indices from ssb-PositionsInBurst, where the beam shape information may include beam pointing direction, beam width, angular specific beamforming gain, or a combination thereof.

FIG. 5 illustrates an example of a multi-dimensional index mapping 500 that supports techniques for indicating parameters associated with an SSB in accordance with one or more aspects of the present disclosure. The multi-dimensional index mapping 500 describes and illustrates the configuration for indicating an explicit multi-dimensional SSB index. The multi-dimensional index mapping 500 may utilized by a UE, a network entity, or some other network device, such as by a UE or a network entity as described with reference to FIGS. 1 through 4.

In some implementations, the UE may receive an explicit indication of a multi-dimensional index associated with an SSB. The SSBs may be transmitted to the UE, or some other receiving device, and the SSBs may be ordered according to the SSB identifiers (IDs). For example, the network entity, the UE, or both may arrange the SSBs in accordance with a corresponding ID (e.g., the SSB #0, SSB #1, SSB #2, and so on). For example, the UE may receive a configuration message (e.g., ServCellConfigCommon) including an SSB bitmap. The SSB bitmap may include up to 64 bits, and each bit may correspond to a particular SSB. The bitmap may be used to indicate the SSBs that the UE is expected to receive (e.g., the subset of SSBs). For example, the serving cell configuration common information element may include a bitmap including 64 bits (e.g., longBitmap BIT STRING (SIZE (64)), where “1's” in the bitmap may indicate which SSBs belong to the subset of SSBs the UE is to measure (e.g., NrofTxSSBs).

Each SSB may then be configured with a first ID along a 1st dimension (e.g., a first index, a first parameter), a second ID along a second dimension (e.g., a second index, a second parameter), . . . and an N^{th} ID along an N^{th} dimension (e.g., an N^{th} index, a N^{th} parameter), such that a multi-dimensional index may include any number of dimensions. For example, the UE may receive a message including the first ID, the second ID, up to the N^{th} ID for each SSB. In some cases, the IDs may correspond to integers mappable to a table 515, such as the table depicted by FIG. 5. The UE may then map each SSB for which the UE received IDs for to a location in a table 515 to identify the beam information, such as the beam shape associated with the corresponding SSB. The serving cell configuration common information element may also include an SSB list field (e.g., ssb-Index-2D-List) that corresponds to the bitmap. The SSB list field may indicate number of multi-dimensional indices included in serving cell configuration common information element. For example, the size of ssb-Index-2D-List (e.g., NrofTxSSBs) may be equal to the “1's” in the bitmap.

In an example of a two-dimensional multi-dimensional index, the UE may receive indication 520 including a first ID of 1 (e.g., an ID associated with the first index 505) and a second ID of 3 (e.g., an ID associated with the second index 510) for SSB #12. The UE may allocate SSB #12 to the location in the table 515 in which an ID of 1 for the first index 505 and an ID of 3 for the second index 510 meet. Similarly, the UE may receive a first ID of 0 and a second ID of 0 for SSB #0. The UE may allocate SSB #0 to the location in the table 515 in which an ID of 0 for the first index 505 and an ID of 0 for the second index 510 meet.

The first index and the second index may be indicated in the serving cell configuration common information element (e.g., ServCellConfigCommon). For example, the serving cell configuration common information element may include a number of multi-dimensional index fields (e.g., SSB-Index-2D). For example, the UE may receive a multi-dimensional index field for each SSB indicated by the SSB indication field (e.g., ssb-Index-2D-List), where each multi-dimensional index field corresponds to a particular SSB. The multi-dimensional index field may include any number of IDs, such as the first ID corresponding to a first dimension and the second ID corresponding to a second dimension.

For example, the UE may receive fifteen multi-dimensional index fields, and each multi-dimensional index field may include two integers, such as a first integer corresponding to a first dimension (e.g., SSB-Index-2D-1st INTEGER {0 . . . . N1max-SSB}) and the second integer corresponding to a second dimension (e.g., SSB-Index-2D-2nd INTEGER {0 . . . . N2max-SSB}). For example, with reference to FIG. 5, the UE may receive a multi-dimensional index for SSB #12 including SSB-Index-2D-1st INTEGER {1} and SSB-Index-2D-2nd INTEGER {3} which may indicate that SSB #12 is to be mapped to the column 1 and row 3 of the table 515.

In some cases, the multi-dimensional index field may include an explicit indication of the SSB corresponding to that multi-dimensional index field. In some cases, the UE may identify which multi-dimensional index field is associated with which SSB based on the ordering of the SSBs and the ordering of the multi-dimensional index fields. For example, the first multi-dimensional index field corresponds to the first activated SSB (e.g., a first SSB of the subset of SSBs indicated by ssb-Index-2D-List), the second multi-dimensional index field corresponds to the second activated SSB, and so on.

The maximum indicatable IDs along respective dimensions may be preconfigured (e.g., predefined), or may be configured by the UE, the network entity, or both, where the maximum indicatable IDs along respective dimensions may define the bounds of the table 515. A maximum indicatable ID for a first dimension (e.g., N1max-SSB) may define the number of columns of the table 515 (e.g., N1max-SSB may be eight as depicted in FIG. 5) and a maximum indicatable ID for a second dimension (e.g., N2max-SSB) may define the number of rows of the table 515 (e.g., N2max-SSB may be four as depicted in FIG. 5). In some cases, the network entity may be preconfigured with the maximum indicatable IDs along respective dimensions and may signal the maximums to the UE, or vice versa. In some cases, the network entity may determine and indicate the maximums to the UE, of vice versa. In some cases, the maximums may be negotiated between the UE and the network entity. In some cases, the maximums may be based on UE capability, network entity capability, or a combination thereof. The maximums may be configured dynamically, semi-statically, or aperiodically. For example, the network entity may configure the indicatable IDs for respective dimensions via ServingCellConfigCommon.

FIG. 6 illustrates an example of a multi-dimensional index mapping 600 that supports techniques for indicating parameters associated with an SSB in accordance with one or more aspects of the present disclosure. The multi-dimensional index mapping 600 describes and illustrates the configuration for indicating a multi-dimensional SSB index implicitly. The multi-dimensional index mapping 600 may utilized by a UE, a network entity, or some other network device, such as by a UE or a network entity as described with reference to FIGS. 1 through 5.

In some implementations, the UE may receive an implicit indication of a multi-dimensional index associated with an SSB. As described with reference to FIG. 5, SSBs may be transmitted to the UE, or some other receiving device, and the SSBs may be ordered according to the SSB IDs. For example, the network entity, the UE, or both may arrange the SSBs in accordance with a corresponding ID (e.g., the SSB #0, SSB #1, SSB #2, and so on). For example, the UE may receive a configuration message (e.g., ServCellConfigCommon) including an SSB bitmap. The SSB bitmap may include up to 64 bits, and each bit may correspond to a particular SSB. The bitmap may be used to indicate the SSBs that the UE is expected to receive (e.g., the subset of SSBs). For example, the serving cell configuration common information element may include a bitmap including 64 bits (e.g., longBitmap BIT STRING (SIZE (64)) indicative of which SSBs belong to the subset.

The UE may then be configured to map each SSB to a multi-dimensional index based on the order of the SSBs. For example, the UE may identify that 32 SSBs are included in the subset based on ssb-PositionsInBurst. The UE may identify that SSB #0 through SSB #31 are included in the subset, where the SSBs may be ordered according to the SSB IDs. The UE may then map the 32 SSBs to multi-dimensional indices, such as by using table 615. The UE may be preconfigured with table 615, determine table 615, or receive an indication of table 615. The table 615 may be defined by dimensions (e.g., S₁, S₂, . . . , S_{N}). For example, S₁ may indicate a number of columns of the table 615 (e.g., S₁=8, as depicted in FIG. 6) and S₂ may indicate a number of rows of the table 615 (e.g., S₂=4, as depicted in FIG. 6). The bit map may define a minimum and a maximum for the dimensions (e.g., S₁min, S₁max, S₂min, S₂max).

In some cases, the ranges of indicatable sizes regarding respective dimensions may be defined. For example, a minimum and maximum size may be configured for each dimension (e.g., S1 min and S1max for the first dimension and S2 min and S2max for the second dimension). The ranges along respective dimensions may be preconfigured (e.g., predefined), or may be configured by the UE, the network entity, or both. In some cases, the network entity may be preconfigured with the ranges of respective dimensions and may signal the ranges to the UE, or vice versa. In some cases, the network entity may determine and indicate the ranges to the UE, of vice versa. In some cases, the ranges may be negotiated between the UE and the network entity. In some cases, the ranges may be based on UE capability, network entity capability, or a combination thereof. The ranges may be configured dynamically, semi-statically, or aperiodically. The network entity may the indicate the table 615 to the UE via ServingCellConfigCommon, wherein the configured table 615 is within the configured ranges.

Upon be configured with the subset of SSBs and the table 615, the UE may then map each SSB for which the UE received IDs for to a location in a table 515 to identify the beam information, such as the beam shape associated with the corresponding SSB. In some implementations, the UE may be configured to sequentially map the SSBs according to the order of the SSBs and the order of the dimensions such that the UE may be configured to perform serial and parallel converting of the SSBs.

For example, in the case of two dimensions, as depicted with reference to FIG. 6. The 1st to the S₁^{th} transmitted SSBs may have the 1st to the S₁^{th} indices regarding the 1^{st} dimension, and the 1st index 605 may be associated with the remaining dimensions. The (S₁+1)th to the 2S₁^{th} SSBs of the subset have the 1st to the S₁^{th} indices regarding the 1^{st} dimension, and the 2^{nd} index 610 associated with the 2^{nd} dimension, and the 1^{st} index 605 associated with the remaining dimensions. The ((S₁−1)×S₁+1)^{th} to the (S₂×S₁)^{th} transmitted SSBs may have the 1^{st} to the S₁^{th} indices regarding the 1^{st} dimension, and the S₂^{th} index associated with the 2^{nd} dimension. Accordingly, the UE may sequentially map the SSBs along the first dimension starting with the first index of the first dimension and the first index of the second dimension (e.g., {0,0}). Upon reaching the end of the first dimension (e.g., column 7), the UE may move to the first index of the first dimension and the second index of the second dimension (e.g., {0,1}), and so on until each SSB is mapped to a location in the table 615.

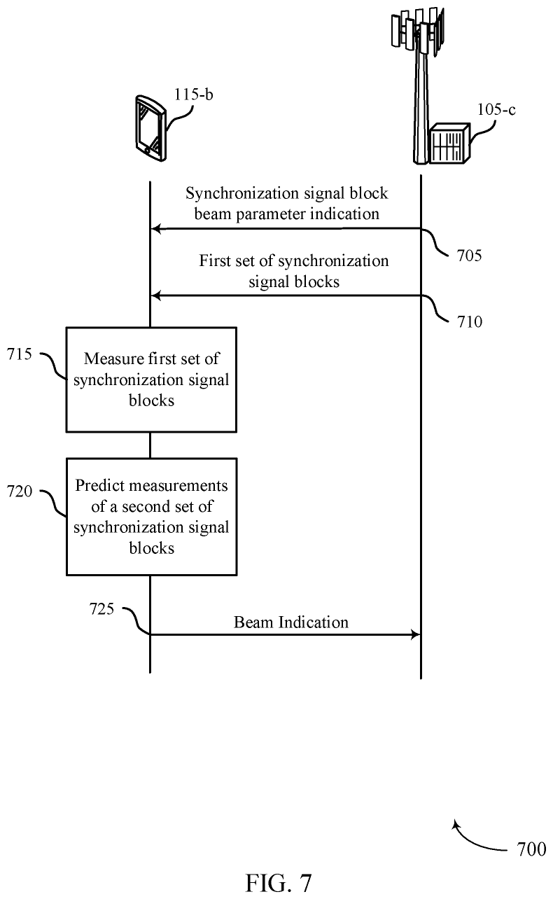

FIG. 7 illustrates an example of a process flow 700 that supports techniques for indicating parameters associated with an SSB in accordance with one or more aspects of the present disclosure. A UE 115-b may be an example of the UE 115 as described with reference to FIGS. 1 through 6, and a network entity 105-c may be an example of the network entity 105 as described with reference to FIGS. 1 through 6. In some cases, different devices may perform the steps described with reference to FIG. 7. Alternative examples of the following may be implemented, where some steps are performed in a different order than described or are not performed at all. In some cases, steps may include additional features not mentioned below, or further steps may be added.

At 705, the UE 115-b may receive, from the network entity 105-c, an SSB beam parameter indication. The SSB beam parameter indication may include a serving cell configuration information element, where the serving cell configuration information element may include a multi-dimensional field indicating a set of multi-dimensional indices associated with a first set of SSBs. A first dimension of a multi-dimensional index may indicate a first beam parameter of an SSB of the first set of SSBs, and a second dimension of the multi-dimensional index may indicate a second beam parameter of the SSB. Receiving the indication may include receiving an RRC control message including the serving call configuration information element, RMSI indicating the set of multi-dimensional indices, OSI indicating the set of multi-dimensional indices. Receiving the indication may include receiving a signal including a first integer associated with the first dimension and a second integer associated with the second dimension of the multi-dimensional index for each SSB of the first set of SSBs.

In some cases, the UE 115-b may map each SSB of the first set of SSBs to a multi-dimensional index table based on the first integer and the second integer corresponding to each SSB. The first integer may indicate a column of the multi-dimensional index table and the second integer may indicate a row of the multi-dimensional index table. The UE 115-b may receive a signal indicating a maximum integer associated with the first dimension and a maximum integer associated with the second dimension. The maximum integer associated with the first dimension may be predefined and a maximum integer associated with the second dimension may be predefined, where the first integer may be less than or equal to a maximum integer associated with the first dimension and the second integer may be less than or equal to a maximum integer associated with the second dimension.

In some cases, the UE 115-b may receive a signal including a first integer indicating a size of the first dimension and a second integer indicating a size of the second dimension. The UE 115-b may map sequentially, each SSB of the first set of SSBs to locations of a multi-dimensional index table based on the first integer and the second integer and an order of SSBs of the first set of SSBs. The UE 115-b may receive a signal indicating an integer range associated with the first dimension and an integer range associated with the second dimension. The first integer may be within the integer range associated with the first dimension and the second integer may be within the integer range associated with the second dimension. The integer range may be defined by a minimum integer and a maximum integer. The first integer may define a number of columns of the multi-dimensional index table and the second integer may define a number of rows of the multi-dimensional index table.

In some examples, the UE 115-b may receive a signal indicating that the first beam parameter is one of an azimuth beam direction, an elevation beam direction, a beam width, a peak beamforming gain, or an angular specific beamforming gain and that the second beam parameter is one of the azimuth beam direction, the elevation beam direction, the beam width, the peak beamforming gain, or the angular specific beamforming gain. The first beam parameter and the second beam parameter may be different.

At 710, the UE 115-b may receive, from the network entity 105-c, the first set of SSBs.

At 715, the UE 115-b may measure the first set of SSBs. The UE 115-b may identify that the first beam parameter is one of an azimuth beam direction, an elevation beam direction, a beam width, a peak beamforming gain, or an angular specific beamforming gain based on a preconfiguration of the first beam parameter or based on an indication from the network entity 105-c, and may identify that the second beam parameter is one of the azimuth beam direction, the elevation beam direction, the beam width, the peak beamforming gain, or the angular specific beamforming gain based on a preconfiguration of the second beam parameter or based on an indication from the network entity 105-c. The first beam parameter and the second beam parameter are different.

At 720, the UE 115-b may predict measurements of a second set of SSBs. The UE 115-b may predict one or more measurements associated with a second set of SSBs based on the first beam parameter, the second beam parameter, and one or more measurements associated with the received first set of SSBs. Predicting one or more measurements may include inputting the first beam parameter, the second beam parameter, and one or more measurements associated with the received first set of SSBs to a beam prediction model, and identifying the one or more measurements associated with the second set of SSBs as outputs of the beam prediction model. The beam prediction model may be an algorithm, a ML model, an AI model, etc.

In some examples, a second set of multi-dimensional indices are associated with a first set of CSI-RSs, where a first dimension of a second multi-dimensional index may indicate a first beam parameter of a CSI-RS of the first set of CSI-RS, and a second dimension of the second multi-dimensional index indicates a second beam parameter of the CSI-RS of the first set of CSI-RS. The UE 115-b may receive the first set of CSI-RSs, and then predict one or more measurements associated with a second set of CSI-RSs based on the first beam parameter, the second beam parameter, and one or more measurements associated with the received first set of CSI-RSs. The set of set of multi-dimensional indices and the second set of multi-dimensional indices may be the same or different.

At 725, the UE 115-b may transmit, and the network entity 105-c may receive, a beam indication. The beam indication may be a message indicating a beam for communications between the UE 115-b and the network entity 105-c based on the one or more measurements associated with the first set of SSBs and the predicted one or more measurements associated with the second set of SSBs. The UE 115-b may transmit a message indicating channel information associated with communications between the UE 115-b and the network entity 105-c based on the one or more measurements associated with the first set of CSI-RS and the predicted one or more measurements associated with the second set of CSI-RSs.

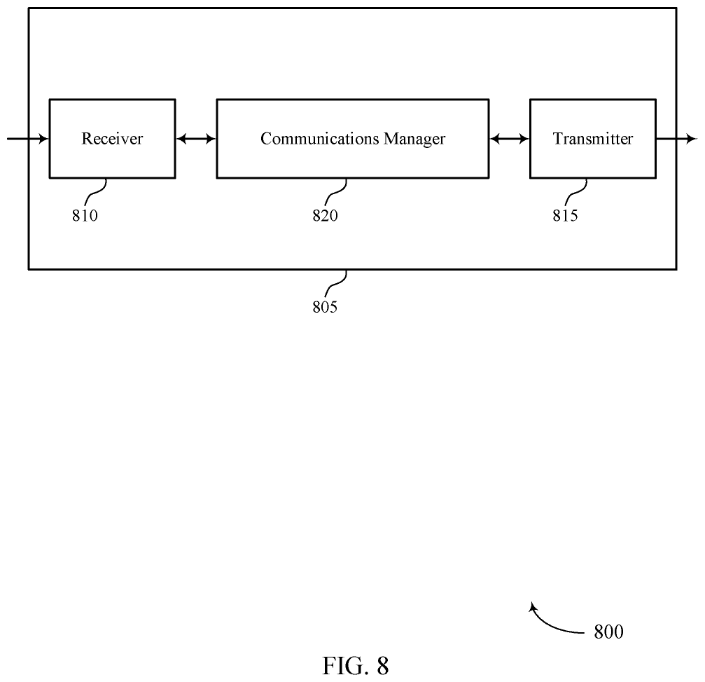

FIG. 8 shows a block diagram 800 of a device 805 that supports techniques for indicating parameters associated with an SSB in accordance with one or more aspects of the present disclosure. The device 805 may be an example of aspects of a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for indicating parameters associated with an SSB). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for indicating parameters associated with an SSB). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of techniques for indicating parameters associated with an SSB as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications at a UE in accordance with examples as disclosed herein. For example, the communications manager 820 may be configured as or otherwise support a means for receiving an indication of a serving cell configuration information element, the serving cell configuration information element including a multi-dimensional field indicative of a set of multi-dimensional indices associated with a first set of SSBs, where a first dimension of a multi-dimensional index indicates a first beam parameter of an SSB of the first set of SSBs, and where a second dimension of the multi-dimensional index indicates a second beam parameter of the SSB. The communications manager 820 may be configured as or otherwise support a means for receiving the first set of SSBs based on the set of multi-dimensional indices. The communications manager 820 may be configured as or otherwise support a means for predicting one or more measurements associated with a second set of SSBs based on the first beam parameter, the second beam parameter, and one or more measurements associated with the received first set of SSBs. The communications manager 820 may be configured as or otherwise support a means for transmitting a message indicating a beam for communications between the UE and a network entity based on the one or more measurements associated with the first set of SSBs and the predicted one or more measurements associated with the second set of SSBs.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for a ML model to predict measurements of a set of SSBs based on measurements of a subset of the SSBs, which may result in reduced processing, reduced power consumption, more efficient utilization of communication resources, etc.

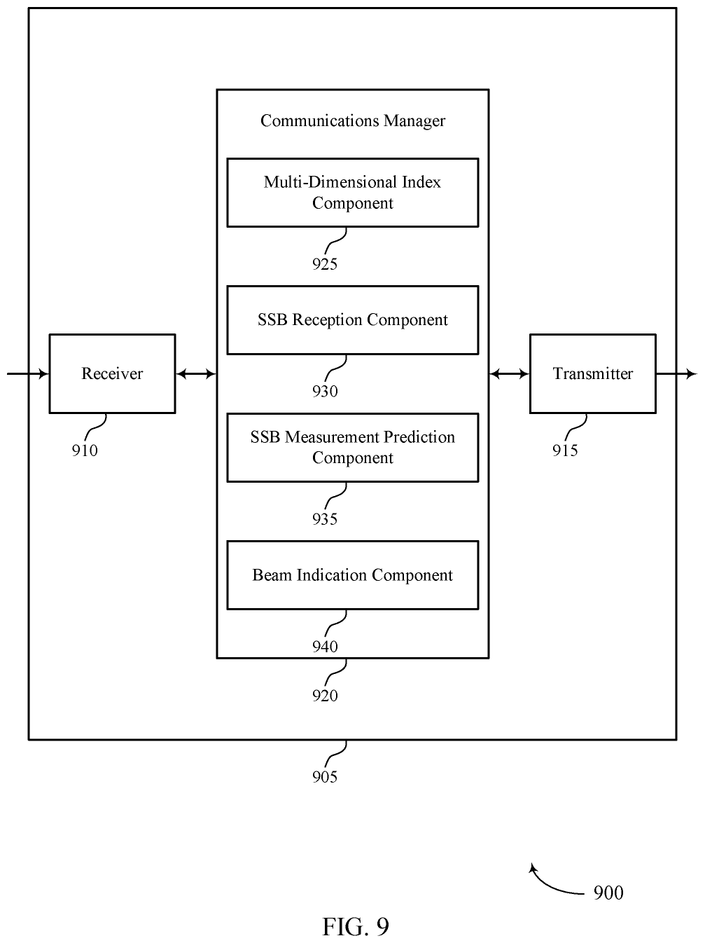

FIG. 9 shows a block diagram 900 of a device 905 that supports techniques for indicating parameters associated with an SSB in accordance with one or more aspects of the present disclosure. The device 905 may be an example of aspects of a device 805 or a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to techniques for indicating parameters associated with an SSB). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to techniques for indicating parameters associated with an SSB). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of techniques for indicating parameters associated with an SSB as described herein. For example, the communications manager 920 may include a multi-dimensional index component 925, an SSB reception component 930, an SSB measurement prediction component 935, a beam indication component 940, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a UE in accordance with examples as disclosed herein. The multi-dimensional index component 925 may be configured as or otherwise support a means for receiving an indication of a serving cell configuration information element, the serving cell configuration information element including a multi-dimensional field indicative of a set of multi-dimensional indices associated with a first set of SSBs, where a first dimension of a multi-dimensional index indicates a first beam parameter of an SSB of the first set of SSBs, and where a second dimension of the multi-dimensional index indicates a second beam parameter of the SSB. The SSB reception component 930 may be configured as or otherwise support a means for receiving the first set of SSBs based on the set of multi-dimensional indices. The SSB measurement prediction component 935 may be configured as or otherwise support a means for predicting one or more measurements associated with a second set of SSBs based on the first beam parameter, the second beam parameter, and one or more measurements associated with the received first set of SSBs. The beam indication component 940 may be configured as or otherwise support a means for transmitting a message indicating a beam for communications between the UE and a network entity based on the one or more measurements associated with the first set of SSBs and the predicted one or more measurements associated with the second set of SSBs.

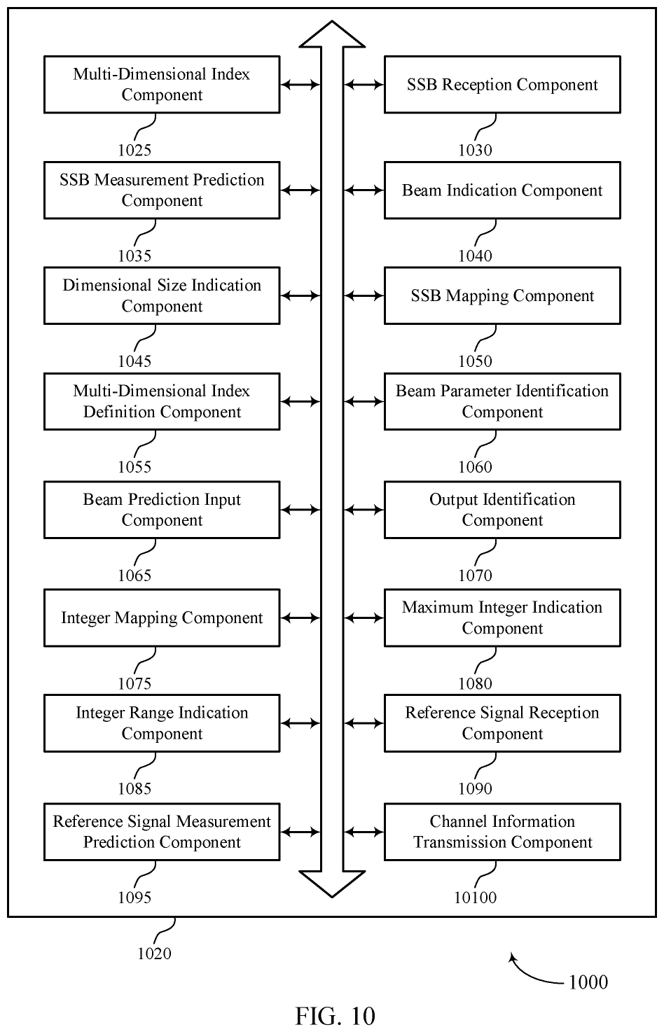

FIG. 10 shows a block diagram 1000 of a communications manager 1020 that supports techniques for indicating parameters associated with an SSB in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of techniques for indicating parameters associated with an SSB as described herein. For example, the communications manager 1020 may include a multi-dimensional index component 1025, an SSB reception component 1030, an SSB measurement prediction component 1035, a beam indication component 1040, a dimensional size indication component 1045, an SSB mapping component 1050, a multi-dimensional index definition component 1055, a beam parameter identification component 1060, a beam prediction input component 1065, an output identification component 1070, an integer mapping component 1075, a maximum integer indication component 1080, an integer range indication component 1085, a reference signal reception component 1090, a reference signal measurement prediction component 1095, a channel information transmission component 10100, or any combination thereof. Each of these components may communicate, directly or indirectly, with one another (e.g., via one or more buses).

The communications manager 1020 may support wireless communications at a UE in accordance with examples as disclosed herein. The multi-dimensional index component 1025 may be configured as or otherwise support a means for receiving an indication of a serving cell configuration information element, the serving cell configuration information element including a multi-dimensional field indicative of a set of multi-dimensional indices associated with a first set of SSBs, where a first dimension of a multi-dimensional index indicates a first beam parameter of an SSB of the first set of SSBs, and where a second dimension of the multi-dimensional index indicates a second beam parameter of the SSB. The SSB reception component 1030 may be configured as or otherwise support a means for receiving the first set of SSBs based on the set of multi-dimensional indices. The SSB measurement prediction component 1035 may be configured as or otherwise support a means for predicting one or more measurements associated with a second set of SSBs based on the first beam parameter, the second beam parameter, and one or more measurements associated with the received first set of SSBs. The beam indication component 1040 may be configured as or otherwise support a means for transmitting a message indicating a beam for communications between the UE and a network entity based on the one or more measurements associated with the first set of SSBs and the predicted one or more measurements associated with the second set of SSBs.

In some examples, to support receiving the indication, the multi-dimensional index component 1025 may be configured as or otherwise support a means for receiving an RRC message including the serving cell configuration information element.

In some examples, to support receiving the indication, the multi-dimensional index component 1025 may be configured as or otherwise support a means for receiving RMSI indicating the set of multi-dimensional indices.

In some examples, to support receiving the indication, the multi-dimensional index component 1025 may be configured as or otherwise support a means for receiving OSI indicating the set of multi-dimensional indices.

In some examples, to support receiving the indication, the multi-dimensional index component 1025 may be configured as or otherwise support a means for receiving a signal including a first integer associated with the first dimension and a second integer associated with the second dimension of the multi-dimensional index for each SSB of the first set of SSBs.

In some examples, the integer mapping component 1075 may be configured as or otherwise support a means for mapping each SSB of the first set of SSBs to a multi-dimensional index table based on the first integer and the second integer corresponding to each SSB.

In some examples, the first integer indicates a column of the multi-dimensional index table and the second integer indicates a row of the multi-dimensional index table.

In some examples, the maximum integer indication component 1080 may be configured as or otherwise support a means for receiving an indication of a maximum integer associated with the first dimension and a maximum integer associated with the second dimension.

In some examples, a maximum integer associated with the first dimension is predefined and a maximum integer associated with the second dimension is predefined.

In some examples, the first integer is less than or equal to a maximum integer associated with the first dimension and the second integer is less than or equal to a maximum integer associated with the second dimension.

In some examples, to support receiving the indication, the dimensional size indication component 1045 may be configured as or otherwise support a means for receiving a signal including a first integer indicative of a size of the first dimension and a second integer indicative of a size of the second dimension. In some examples, to support receiving the indication, the SSB mapping component 1050 may be configured as or otherwise support a means for mapping, sequentially, each SSB of the first set of SSBs to locations of a multi-dimensional index table based on the first integer and the second integer and an order of SSBs of the first set of SSBs.

In some examples, the integer range indication component 1085 may be configured as or otherwise support a means for receiving an indication of an integer range associated with the first dimension and an integer range associated with the second dimension, the first integer being within the integer range associated with the first dimension and the second integer being within the integer range associated with the second dimension, where the integer range associated with the first dimension, the second dimension, or both is defined by a minimum integer and a maximum integer.

In some examples, the first integer defines a number of columns of the multi-dimensional index table and the second integer defines a number of rows of the multi-dimensional index table.

In some examples, the multi-dimensional index definition component 1055 may be configured as or otherwise support a means for receiving a signal indicating that the first beam parameter is one of an azimuth beam direction, an elevation beam direction, a beam width, a peak beamforming gain, or an angular specific beamforming gain and that the second beam parameter is one of the azimuth beam direction, the elevation beam direction, the beam width, the peak beamforming gain, or the angular specific beamforming gain, where the first beam parameter and the second beam parameter are different.

In some examples, the beam parameter identification component 1060 may be configured as or otherwise support a means for identifying that the first beam parameter is one of an azimuth beam direction, an elevation beam direction, a beam width, a peak beamforming gain, or an angular specific beamforming gain based on a preconfiguration of the first beam parameter. In some examples, the beam parameter identification component 1060 may be configured as or otherwise support a means for identifying that the second beam parameter is one of the azimuth beam direction, the elevation beam direction, the beam width, the peak beamforming gain, or the angular specific beamforming gain based on a preconfiguration of the second beam parameter, where the first beam parameter and the second beam parameter are different.

In some examples, to support predicting the one or more measurements, the beam prediction input component 1065 may be configured as or otherwise support a means for inputting the first beam parameter, the second beam parameter, and one or more measurements associated with the received first set of SSBs to a beam prediction model. In some examples, to support predicting the one or more measurements, the output identification component 1070 may be configured as or otherwise support a means for identifying the one or more measurements associated with the second set of SSBs as outputs of the beam prediction model.

In some examples, the beam prediction model is an algorithm or a ML model.

In some examples, a second set of multi-dimensional indices are associated with a first set of CSI-RSs. In some examples, a first dimension of a second multi-dimensional index indicates a first beam parameter of a CSI-RS of the first set CSI-RSs. In some examples, a second dimension of the second multi-dimensional index indicates a second beam parameter of the CSI-RS of the first set of CSI-RSs.

In some examples, the reference signal reception component 1090 may be configured as or otherwise support a means for receiving the first set of CSI-RSs based on the second set of multi-dimensional indices. In some examples, the reference signal measurement prediction component 1095 may be configured as or otherwise support a means for predicting one or more measurements associated with a second set of CSI-RSs based on the first beam parameter of the CSI-RS, the second beam parameter of the CSI-RS, and one or more measurements associated with the received first set of CSI-RSs. In some examples, the channel information transmission component 10100 may be configured as or otherwise support a means for transmitting a second message indicating channel information associated with communications between the UE and the network entity based on the one or more measurements associated with the first set of CSI-RSs and the predicted one or more measurements associated with the second set of CSI-RSs.

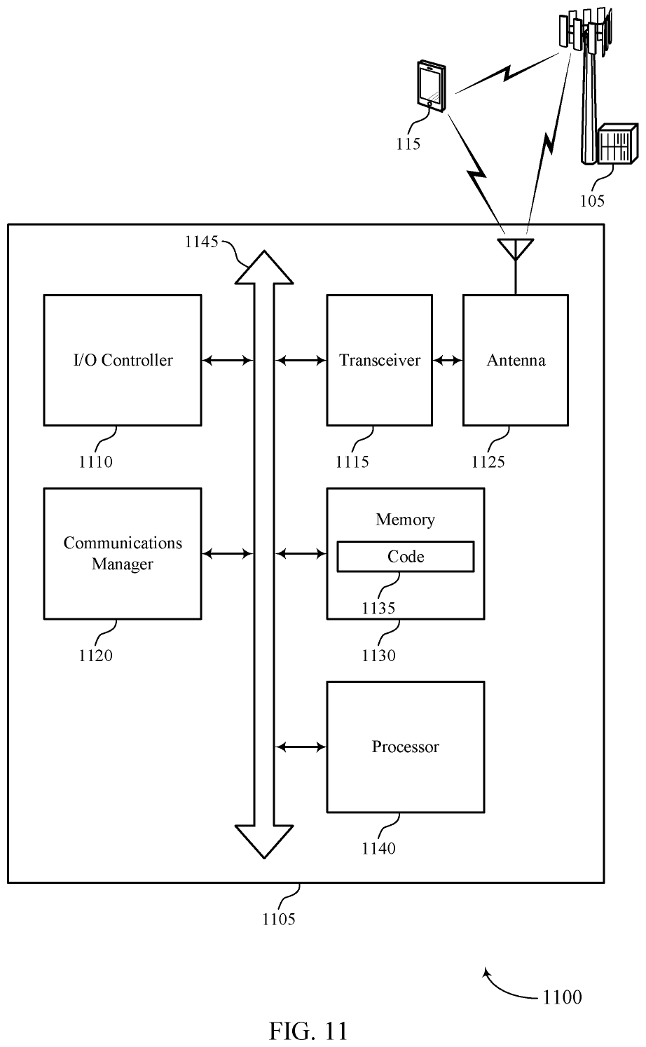

FIG. 11 shows a diagram of a system 1100 including a device 1105 that supports techniques for indicating parameters associated with an SSB in accordance with one or more aspects of the present disclosure. The device 1105 may be an example of or include the components of a device 805, a device 905, or a UE 115 as described herein. The device 1105 may communicate (e.g., wirelessly) with one or more network entities 105, one or more UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a basic I/O system (BIOS) which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting techniques for indicating parameters associated with an SSB). For example, the device 1105 or a component of the device 1105 may include a processor 1140 and memory 1130 coupled with or to the processor 1140, the processor 1140 and memory 1130 configured to perform various functions described herein.

The communications manager 1120 may support wireless communications at a UE in accordance with examples as disclosed herein. For example, the communications manager 1120 may be configured as or otherwise support a means for receiving an indication of a serving cell configuration information element, the serving cell configuration information element including a multi-dimensional field indicative of a set of multi-dimensional indices associated with a first set of SSBs, where a first dimension of a multi-dimensional index indicates a first beam parameter of an SSB of the first set of SSBs, and where a second dimension of the multi-dimensional index indicates a second beam parameter of the SSB. The communications manager 1120 may be configured as or otherwise support a means for receiving the first set of SSBs based on the set of multi-dimensional indices. The communications manager 1120 may be configured as or otherwise support a means for predicting one or more measurements associated with a second set of SSBs based on the first beam parameter, the second beam parameter, and one or more measurements associated with the received first set of SSBs. The communications manager 1120 may be configured as or otherwise support a means for transmitting a message indicating a beam for communications between the UE and a network entity based on the one or more measurements associated with the first set of SSBs and the predicted one or more measurements associated with the second set of SSBs.

By including or configuring the communications manager 1120 in accordance with examples as described herein, the device 1105 may support techniques for a ML model to predict measurements of a set of SSBs based on measurements of a subset of the SSBs, which may result in improved communication reliability, reduced latency, improved user experience related to reduced processing, reduced power consumption, more efficient utilization of communication resources, improved coordination between devices, longer battery life, improved utilization of processing capability, etc.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of techniques for indicating parameters associated with an SSB as described herein, or the processor 1140 and the memory 1130 may be otherwise configured to perform or support such operations.

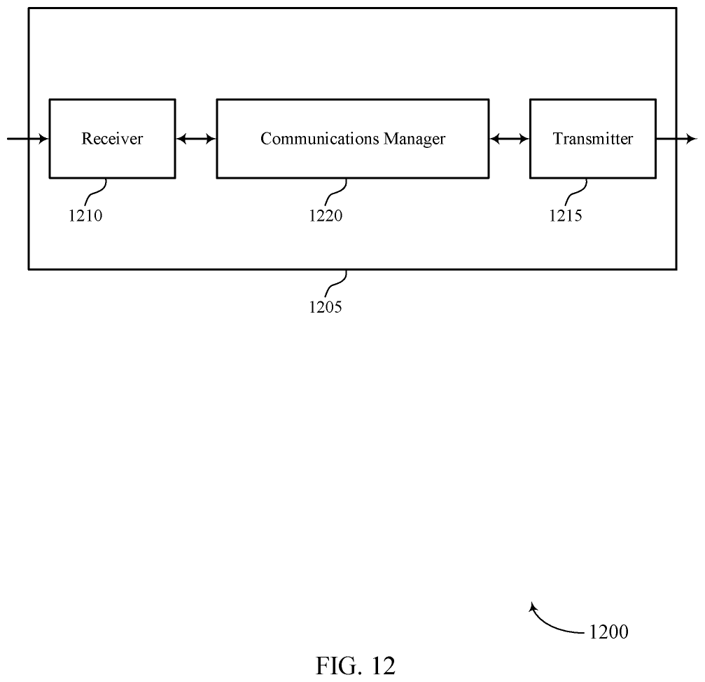

FIG. 12 shows a block diagram 1200 of a device 1205 that supports techniques for indicating parameters associated with an SSB in accordance with one or more aspects of the present disclosure. The device 1205 may be an example of aspects of a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The communications manager 1220, the receiver 1210, the transmitter 1215, or various combinations thereof or various components thereof may be examples of means for performing various aspects of techniques for indicating parameters associated with an SSB as described herein. For example, the communications manager 1220, the receiver 1210, the transmitter 1215, or various combinations or components thereof may support a method for performing one or more of the functions described herein.

In some examples, the communications manager 1220, the receiver 1210, the transmitter 1215, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1220, the receiver 1210, the transmitter 1215, or various combinations or components thereof may be implemented in code (e.g., as communications management software or firmware) executed by a processor. If implemented in code executed by a processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications at a network entity in accordance with examples as disclosed herein. For example, the communications manager 1220 may be configured as or otherwise support a means for transmitting an indication of a serving cell configuration information element, the serving cell configuration information element including a multi-dimensional field indicative of a set of multi-dimensional indices associated with a first set of SSBs, where a first dimension of a multi-dimensional index indicates a first beam parameter of an SSB of the first set of SSBs, and where a second dimension of the multi-dimensional index indicates a second beam parameter of the SSB. The communications manager 1220 may be configured as or otherwise support a means for transmitting the first set of SSBs based on the set of multi-dimensional indices. The communications manager 1220 may be configured as or otherwise support a means for receiving a message indicating a beam for communications between a UE and the network entity, where the beam is associated with the first set of SSBs or a second set of SSBs.

By including or configuring the communications manager 1220 in accordance with examples as described herein, the device 1205 (e.g., a processor controlling or otherwise coupled with the receiver 1210, the transmitter 1215, the communications manager 1220, or a combination thereof) may support techniques for a ML model to predict measurements of a set of SSBs based on measurements of a subset of the SSBs, which may result in reduced processing, reduced power consumption, more efficient utilization of communication resources, etc.

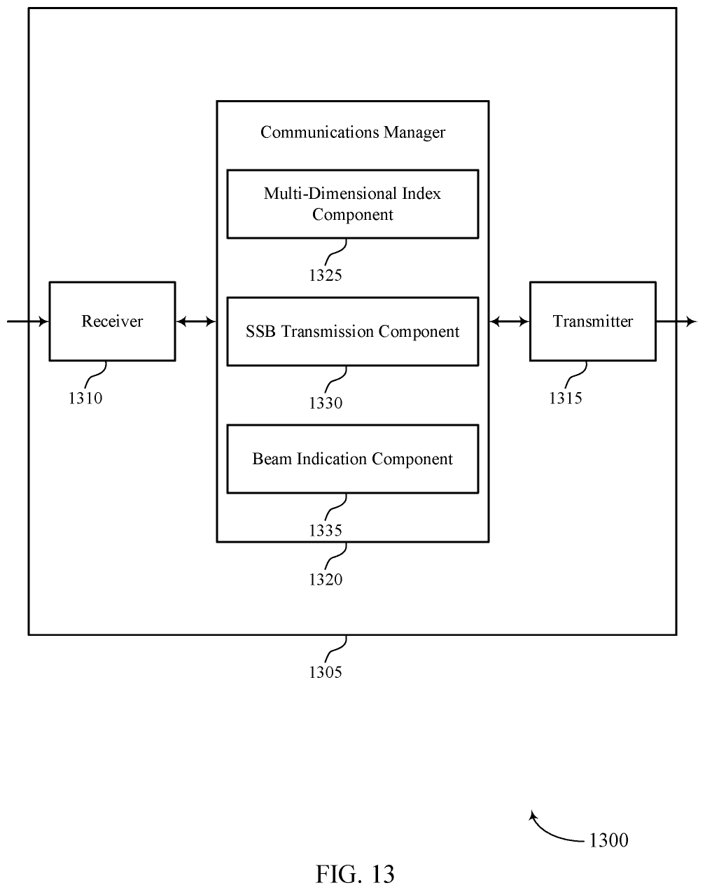

FIG. 13 shows a block diagram 1300 of a device 1305 that supports techniques for indicating parameters associated with an SSB in accordance with one or more aspects of the present disclosure. The device 1305 may be an example of aspects of a device 1205 or a network entity 105 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The device 1305, or various components thereof, may be an example of means for performing various aspects of techniques for indicating parameters associated with an SSB as described herein. For example, the communications manager 1320 may include a multi-dimensional index component 1325, an SSB transmission component 1330, a beam indication component 1335, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications at a network entity in accordance with examples as disclosed herein. The multi-dimensional index component 1325 may be configured as or otherwise support a means for transmitting an indication of a serving cell configuration information element, the serving cell configuration information element including a multi-dimensional field indicative of a set of multi-dimensional indices associated with a first set of SSBs, where a first dimension of a multi-dimensional index indicates a first beam parameter of an SSB of the first set of SSBs, and where a second dimension of the multi-dimensional index indicates a second beam parameter of the SSB. The SSB transmission component 1330 may be configured as or otherwise support a means for transmitting the first set of SSBs based on the set of multi-dimensional indices. The beam indication component 1335 may be configured as or otherwise support a means for receiving a message indicating a beam for communications between a UE and the network entity, where the beam is associated with the first set of SSBs or a second set of SSBs.

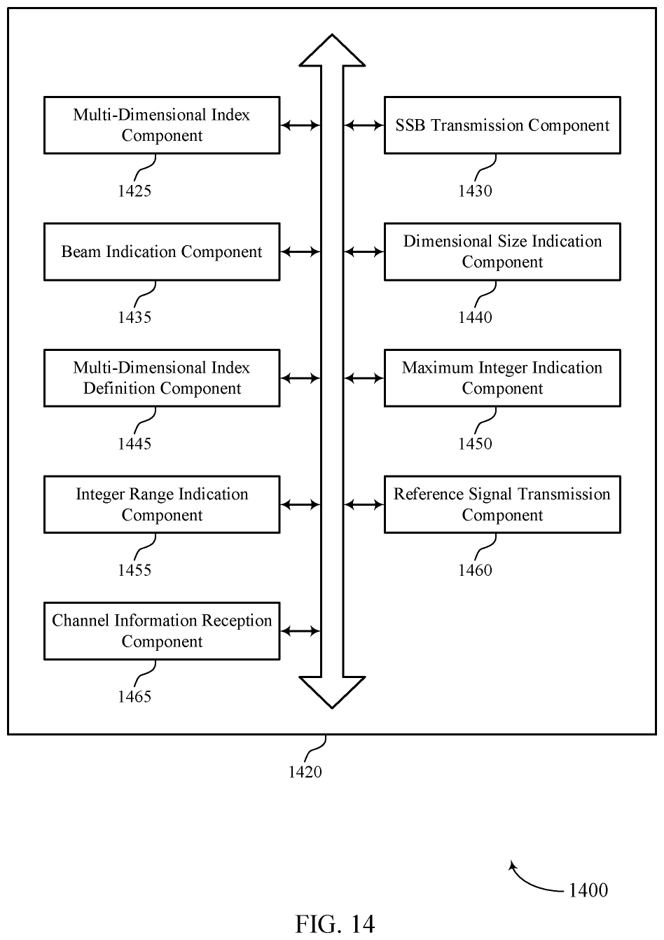

FIG. 14 shows a block diagram 1400 of a communications manager 1420 that supports techniques for indicating parameters associated with an SSB in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of techniques for indicating parameters associated with an SSB as described herein. For example, the communications manager 1420 may include a multi-dimensional index component 1425, an SSB transmission component 1430, a beam indication component 1435, a dimensional size indication component 1440, a multi-dimensional index definition component 1445, a maximum integer indication component 1450, an integer range indication component 1455, a reference signal transmission component 1460, a channel information reception component 1465, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1420 may support wireless communications at a network entity in accordance with examples as disclosed herein. The multi-dimensional index component 1425 may be configured as or otherwise support a means for transmitting an indication of a serving cell configuration information element, the serving cell configuration information element including a multi-dimensional field indicative of a set of multi-dimensional indices associated with a first set of SSBs, where a first dimension of a multi-dimensional index indicates a first beam parameter of an SSB of the first set of SSBs, and where a second dimension of the multi-dimensional index indicates a second beam parameter of the SSB. The SSB transmission component 1430 may be configured as or otherwise support a means for transmitting the first set of SSBs based on the set of multi-dimensional indices. The beam indication component 1435 may be configured as or otherwise support a means for receiving a message indicating a beam for communications between a UE and the network entity, where the beam is associated with the first set of SSBs or a second set of SSBs.

In some examples, to support transmitting the indication, the multi-dimensional index component 1425 may be configured as or otherwise support a means for transmitting an RRC message including the serving cell configuration information element.

In some examples, to support transmitting the indication, the multi-dimensional index component 1425 may be configured as or otherwise support a means for transmitting RMSI indicating the set of multi-dimensional indices.

In some examples, to support transmitting the indication, the multi-dimensional index component 1425 may be configured as or otherwise support a means for transmitting OSI indicating the set of multi-dimensional indices.

In some examples, to support transmitting the indication, the multi-dimensional index component 1425 may be configured as or otherwise support a means for transmitting a signal including a first integer associated with the first dimension and a second integer associated with the second dimension of the multi-dimensional index for each SSB of the first set of SSBs.

In some examples, each SSB of the first set of SSBs is mappable to a multi-dimensional index table based on the first integer and the second integer corresponding to each SSB.

In some examples, the first integer indicates a column of the multi-dimensional index table and the second integer indicates a row of the multi-dimensional index table.

In some examples, the maximum integer indication component 1450 may be configured as or otherwise support a means for transmitting an indication of a maximum integer associated with the first dimension and a maximum integer associated with the second dimension.

In some examples, a maximum integer associated with the first dimension is predefined and a maximum integer associated with the second dimension is predefined.

In some examples, the first integer is less than or equal to a maximum integer associated with the first dimension and the second integer is less than or equal to a maximum integer associated with the second dimension.

In some examples, to support transmitting the indication, the dimensional size indication component 1440 may be configured as or otherwise support a means for transmitting a signal including a first integer indicative of a size of the first dimension and a second integer indicative of a size of the second dimension, where each SSB of the first set of SSBs is mappable, sequentially, to locations of a multi-dimensional index table based on the first integer and the second integer and an order of SSBs of the first set of SSBs.

In some examples, the integer range indication component 1455 may be configured as or otherwise support a means for transmitting a signal indicating an integer range associated with the first dimension and an integer range associated with the second dimension, the first integer being within the integer range associated with the first dimension and the second integer being within the integer range associated with the second dimension, where the integer range associated with the first dimension, the second dimension, or both is defined by a minimum integer and a maximum integer.

In some examples, the first integer defines a number of columns of the multi-dimensional index table and the second integer defines a number of rows of the multi-dimensional index table.

In some examples, the multi-dimensional index definition component 1445 may be configured as or otherwise support a means for transmitting a signal indicating that the first beam parameter is one of an azimuth beam direction, an elevation beam direction, a beam width, a peak beamforming gain, or an angular specific beamforming gain and that the second beam parameter is one of the azimuth beam direction, the elevation beam direction, the beam width, the peak beamforming gain, or the angular specific beamforming gain, where the first beam parameter and the second beam parameter are different.

In some examples, a second set of multi-dimensional indices are associated with a first set of CSI-RSs. In some examples, a first dimension of a second multi-dimensional index indicates a first beam parameter of a CSI-RS of the first set of CSI-RSs. In some examples, a second dimension of the second multi-dimensional index indicates a second beam parameter of the CSI-RS of the first set of CSI-RSs.

In some examples, the reference signal transmission component 1460 may be configured as or otherwise support a means for transmitting the first set of CSI-RSs based on the second set of multi-dimensional indices. In some examples, the channel information reception component 1465 may be configured as or otherwise support a means for receiving a message indicating channel information associated with communications between the UE and the network entity, where the channel information is associated with the first set of CSI-RSs, a second set of CSI-RSs, or both.

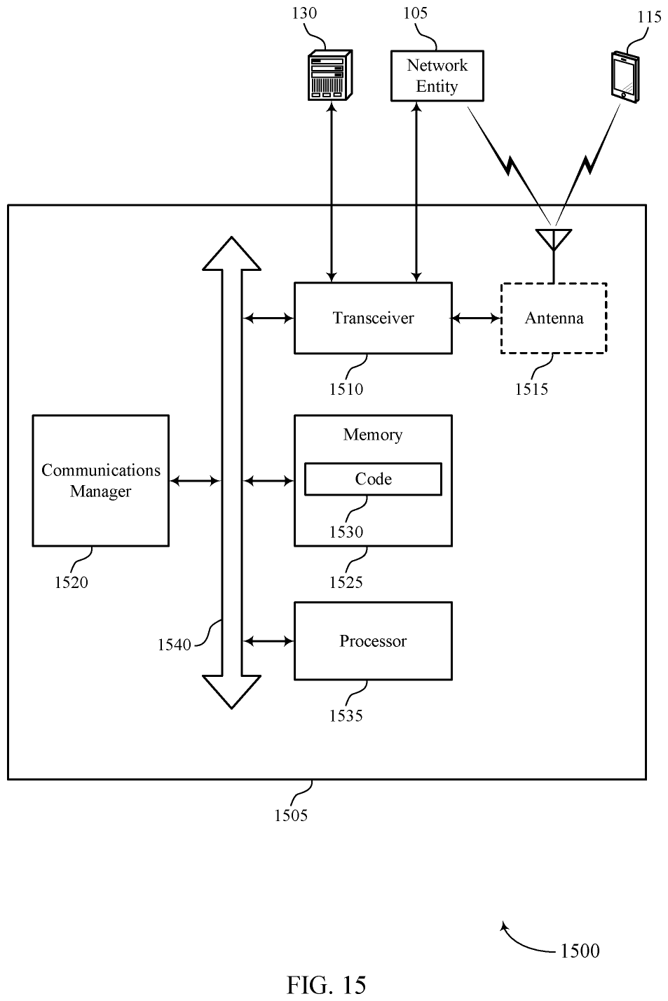

FIG. 15 shows a diagram of a system 1500 including a device 1505 that supports techniques for indicating parameters associated with an SSB in accordance with one or more aspects of the present disclosure. The device 1505 may be an example of or include the components of a device 1205, a device 1305, or a network entity 105 as described herein. The device 1505 may communicate with one or more network entities 105, one or more UEs 115, or any combination thereof, which may include communications over one or more wired interfaces, over one or more wireless interfaces, or any combination thereof. The device 1505 may include components that support outputting and obtaining communications, such as a communications manager 1520, a transceiver 1510, an antenna 1515, a memory 1525, code 1530, and a processor 1535. These components may be in electronic communication or otherwise coupled (e.g., operatively, communicatively, functionally, electronically, electrically) via one or more buses (e.g., a bus 1540).

The transceiver 1510 may support bi-directional communications via wired links, wireless links, or both as described herein. In some examples, the transceiver 1510 may include a wired transceiver and may communicate bi-directionally with another wired transceiver. Additionally, or alternatively, in some examples, the transceiver 1510 may include a wireless transceiver and may communicate bi-directionally with another wireless transceiver. In some examples, the device 1505 may include one or more antennas 1515, which may be capable of transmitting or receiving wireless transmissions (e.g., concurrently). The transceiver 1510 may also include a modem to modulate signals, to provide the modulated signals for transmission (e.g., by one or more antennas 1515, by a wired transmitter), to receive modulated signals (e.g., from one or more antennas 1515, from a wired receiver), and to demodulate signals. In some implementations, the transceiver 1510 may include one or more interfaces, such as one or more interfaces coupled with the one or more antennas 1515 that are configured to support various receiving or obtaining operations, or one or more interfaces coupled with the one or more antennas 1515 that are configured to support various transmitting or outputting operations, or a combination thereof. In some implementations, the transceiver 1510 may include or be configured for coupling with one or more processors or memory components that are operable to perform or support operations based on received or obtained information or signals, or to generate information or other signals for transmission or other outputting, or any combination thereof. In some implementations, the transceiver 1510, or the transceiver 1510 and the one or more antennas 1515, or the transceiver 1510 and the one or more antennas 1515 and one or more processors or memory components (for example, the processor 1535, or the memory 1525, or both), may be included in a chip or chip assembly that is installed in the device 1505. In some examples, the transceiver may be operable to support communications via one or more communications links (e.g., a communication link 125, a backhaul communication link 120, a midhaul communication link 162, a fronthaul communication link 168).

The memory 1525 may include RAM and ROM. The memory 1525 may store computer-readable, computer-executable code 1530 including instructions that, when executed by the processor 1535, cause the device 1505 to perform various functions described herein. The code 1530 may be stored in a non-transitory computer-readable medium such as system memory or another type of memory. In some cases, the code 1530 may not be directly executable by the processor 1535 but may cause a computer (e.g., when compiled and executed) to perform functions described herein. In some cases, the memory 1525 may contain, among other things, a BIOS which may control basic hardware or software operation such as the interaction with peripheral components or devices.

The processor 1535 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1535 may be configured to operate a memory array using a memory controller. In some other cases, a memory controller may be integrated into the processor 1535. The processor 1535 may be configured to execute computer-readable instructions stored in a memory (e.g., the memory 1525) to cause the device 1505 to perform various functions (e.g., functions or tasks supporting techniques for indicating parameters associated with an SSB). For example, the device 1505 or a component of the device 1505 may include a processor 1535 and memory 1525 coupled with the processor 1535, the processor 1535 and memory 1525 configured to perform various functions described herein. The processor 1535 may be an example of a cloud-computing platform (e.g., one or more physical nodes and supporting software such as operating systems, virtual machines, or container instances) that may host the functions (e.g., by executing code 1530) to perform the functions of the device 1505. The processor 1535 may be any one or more suitable processors capable of executing scripts or instructions of one or more software programs stored in the device 1505 (such as within the memory 1525). In some implementations, the processor 1535 may be a component of a processing system. A processing system may generally refer to a system or series of machines or components that receives inputs and processes the inputs to produce a set of outputs (which may be passed to other systems or components of, for example, the device 1505). For example, a processing system of the device 1505 may refer to a system including the various other components or subcomponents of the device 1505, such as the processor 1535, or the transceiver 1510, or the communications manager 1520, or other components or combinations of components of the device 1505. The processing system of the device 1505 may interface with other components of the device 1505, and may process information received from other components (such as inputs or signals) or output information to other components. For example, a chip or modem of the device 1505 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1505 may transmit information output from the chip or modem. Additionally, or alternatively, in some implementations, the one or more interfaces may refer to an interface between the processing system of the chip or modem and a receiver, such that the device 1505 may obtain information or signal inputs, and the information may be passed to the processing system. A person having ordinary skill in the art will readily recognize that a first interface also may obtain information or signal inputs, and a second interface also may output information or signal outputs.

In some examples, a bus 1540 may support communications of (e.g., within) a protocol layer of a protocol stack. In some examples, a bus 1540 may support communications associated with a logical channel of a protocol stack (e.g., between protocol layers of a protocol stack), which may include communications performed within a component of the device 1505, or between different components of the device 1505 that may be co-located or located in different locations (e.g., where the device 1505 may refer to a system in which one or more of the communications manager 1520, the transceiver 1510, the memory 1525, the code 1530, and the processor 1535 may be located in one of the different components or divided between different components).

In some examples, the communications manager 1520 may manage aspects of communications with a core network 130 (e.g., via one or more wired or wireless backhaul links). For example, the communications manager 1520 may manage the transfer of data communications for client devices, such as one or more UEs 115. In some examples, the communications manager 1520 may manage communications with other network entities 105, and may include a controller or scheduler for controlling communications with UEs 115 in cooperation with other network entities 105. In some examples, the communications manager 1520 may support an X2 interface within an LTE/LTE-A wireless communications network technology to provide communication between network entities 105.

The communications manager 1520 may support wireless communications at a network entity in accordance with examples as disclosed herein. For example, the communications manager 1520 may be configured as or otherwise support a means for transmitting an indication of a serving cell configuration information element, the serving cell configuration information element including a multi-dimensional field indicative of a set of multi-dimensional indices associated with a first set of SSBs, where a first dimension of a multi-dimensional index indicates a first beam parameter of an SSB of the first set of SSBs, and where a second dimension of the multi-dimensional index indicates a second beam parameter of the SSB. The communications manager 1520 may be configured as or otherwise support a means for transmitting the first set of SSBs based on the set of multi-dimensional indices. The communications manager 1520 may be configured as or otherwise support a means for receiving a message indicating a beam for communications between a UE and the network entity, where the beam is associated with the first set of SSBs or a second set of SSBs.

By including or configuring the communications manager 1520 in accordance with examples as described herein, the device 1505 may support techniques for a ML model to predict measurements of a set of SSBs based on measurements of a subset of the SSBs, which may result in improved communication reliability, reduced latency, improved user experience related to reduced processing, reduced power consumption, more efficient utilization of communication resources, improved coordination between devices, longer battery life, improved utilization of processing capability, etc.

In some examples, the communications manager 1520 may be configured to perform various operations (e.g., receiving, obtaining, monitoring, outputting, transmitting) using or otherwise in cooperation with the transceiver 1510, the one or more antennas 1515 (e.g., where applicable), or any combination thereof. Although the communications manager 1520 is illustrated as a separate component, in some examples, one or more functions described with reference to the communications manager 1520 may be supported by or performed by the transceiver 1510, the processor 1535, the memory 1525, the code 1530, or any combination thereof. For example, the code 1530 may include instructions executable by the processor 1535 to cause the device 1505 to perform various aspects of techniques for indicating parameters associated with an SSB as described herein, or the processor 1535 and the memory 1525 may be otherwise configured to perform or support such operations.

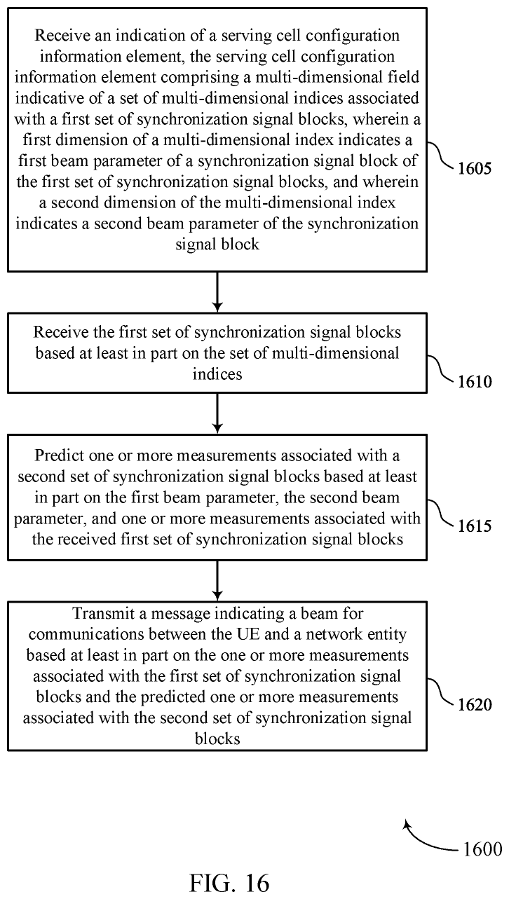

FIG. 16 shows a flowchart illustrating a method 1600 that supports techniques for indicating parameters associated with an SSB in accordance with one or more aspects of the present disclosure. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1605, the method may include receiving an indication of a serving cell configuration information element, the serving cell configuration information element including a multi-dimensional field indicative of a set of multi-dimensional indices associated with a first set of SSBs, where a first dimension of a multi-dimensional index indicates a first beam parameter of an SSB of the first set of SSBs, and where a second dimension of the multi-dimensional index indicates a second beam parameter of the SSB. The operations of 1605 may be performed in accordance with examples as disclosed herein. In some examples, aspects of the operations of 1605 may be performed by a multi-dimensional index component 1025 as described with reference to FIG. 10.

At 1610, the method may include receiving the first set of SSBs based on the set of multi-dimensional indices. The operations of 1610 may be performed in accordance with examples as disclosed herein. In some examples, aspects of the operations of 1610 may be performed by an SSB reception component 1030 as described with reference to FIG. 10.

At 1615, the method may include predicting one or more measurements associated with a second set of SSBs based on the first beam parameter, the second beam parameter, and one or more measurements associated with the received first set of SSBs. The operations of 1615 may be performed in accordance with examples as disclosed herein. In some examples, aspects of the operations of 1615 may be performed by an SSB measurement prediction component 1035 as described with reference to FIG. 10.

At 1620, the method may include transmitting a message indicating a beam for communications between the UE and a network entity based on the one or more measurements associated with the first set of SSBs and the predicted one or more measurements associated with the second set of SSBs. The operations of 1620 may be performed in accordance with examples as disclosed herein. In some examples, aspects of the operations of 1620 may be performed by a beam indication component 1040 as described with reference to FIG. 10.

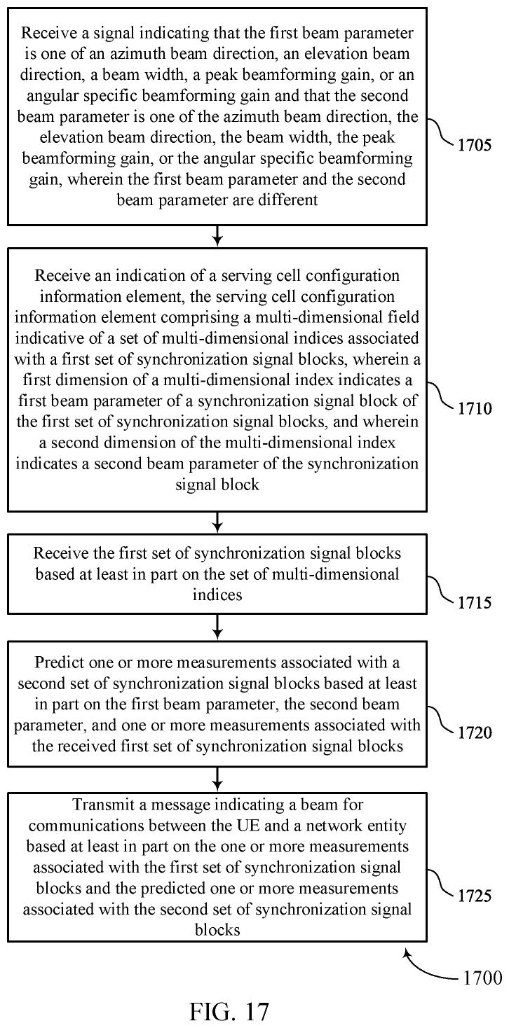

FIG. 17 shows a flowchart illustrating a method 1700 that supports techniques for indicating parameters associated with an SSB in accordance with one or more aspects of the present disclosure. The operations of the method 1700 may be implemented by a UE or its components as described herein. For example, the operations of the method 1700 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1705, the method may include receiving a signal indicating that the first beam parameter is one of an azimuth beam direction, an elevation beam direction, a beam width, a peak beamforming gain, or an angular specific beamforming gain and that the second beam parameter is one of the azimuth beam direction, the elevation beam direction, the beam width, the peak beamforming gain, or the angular specific beamforming gain, where the first beam parameter and the second beam parameter are different. The operations of 1705 may be performed in accordance with examples as disclosed herein. In some examples, aspects of the operations of 1705 may be performed by a multi-dimensional index definition component 1055 as described with reference to FIG. 10.

At 1710, the method may include receiving an indication of a serving cell configuration information element, the serving cell configuration information element including a multi-dimensional field indicative of a set of multi-dimensional indices associated with a first set of SSBs, where a first dimension of a multi-dimensional index indicates a first beam parameter of an SSB of the first set of SSBs, and where a second dimension of the multi-dimensional index indicates a second beam parameter of the SSB. The operations of 1710 may be performed in accordance with examples as disclosed herein. In some examples, aspects of the operations of 1710 may be performed by a multi-dimensional index component 1025 as described with reference to FIG. 10.

At 1715, the method may include receiving the first set of SSBs based on the set of multi-dimensional indices. The operations of 1715 may be performed in accordance with examples as disclosed herein. In some examples, aspects of the operations of 1715 may be performed by an SSB reception component 1030 as described with reference to FIG. 10.

At 1720, the method may include predicting one or more measurements associated with a second set of SSBs based on the first beam parameter, the second beam parameter, and one or more measurements associated with the received first set of SSBs. The operations of 1720 may be performed in accordance with examples as disclosed herein. In some examples, aspects of the operations of 1720 may be performed by an SSB measurement prediction component 1035 as described with reference to FIG. 10.

At 1725, the method may include transmitting a message indicating a beam for communications between the UE and a network entity based on the one or more measurements associated with the first set of SSBs and the predicted one or more measurements associated with the second set of SSBs. The operations of 1725 may be performed in accordance with examples as disclosed herein. In some examples, aspects of the operations of 1725 may be performed by a beam indication component 1040 as described with reference to FIG. 10.

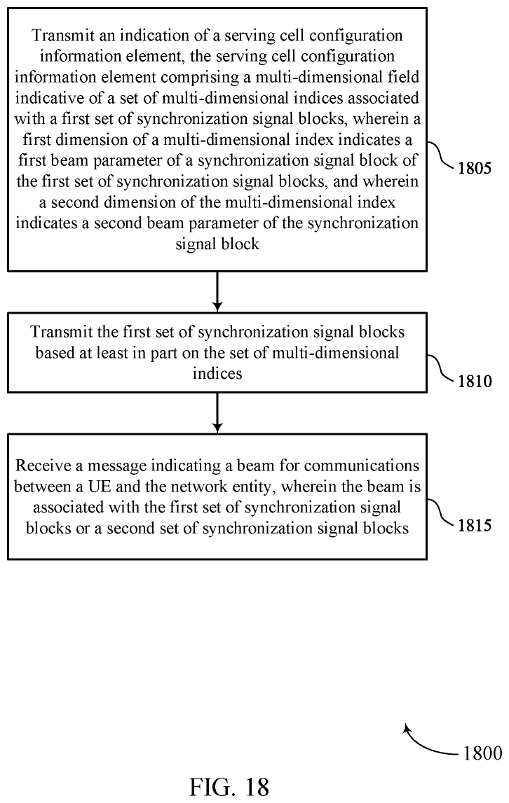

FIG. 18 shows a flowchart illustrating a method 1800 that supports techniques for indicating parameters associated with an SSB in accordance with one or more aspects of the present disclosure. The operations of the method 1800 may be implemented by a network entity or its components as described herein. For example, the operations of the method 1800 may be performed by a network entity as described with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 1805, the method may include transmitting an indication of a serving cell configuration information element, the serving cell configuration information element including a multi-dimensional field indicative of a set of multi-dimensional indices associated with a first set of SSBs, where a first dimension of a multi-dimensional index indicates a first beam parameter of an SSB of the first set of SSBs, and where a second dimension of the multi-dimensional index indicates a second beam parameter of the SSB. The operations of 1805 may be performed in accordance with examples as disclosed herein. In some examples, aspects of the operations of 1805 may be performed by a multi-dimensional index component 1425 as described with reference to FIG. 14.

At 1810, the method may include transmitting the first set of SSBs based on the set of multi-dimensional indices. The operations of 1810 may be performed in accordance with examples as disclosed herein. In some examples, aspects of the operations of 1810 may be performed by an SSB transmission component 1430 as described with reference to FIG. 14.

At 1815, the method may include receiving a message indicating a beam for communications between a UE and the network entity, where the beam is associated with the first set of SSBs or a second set of SSBs. The operations of 1815 may be performed in accordance with examples as disclosed herein. In some examples, aspects of the operations of 1815 may be performed by a beam indication component 1435 as described with reference to FIG. 14.

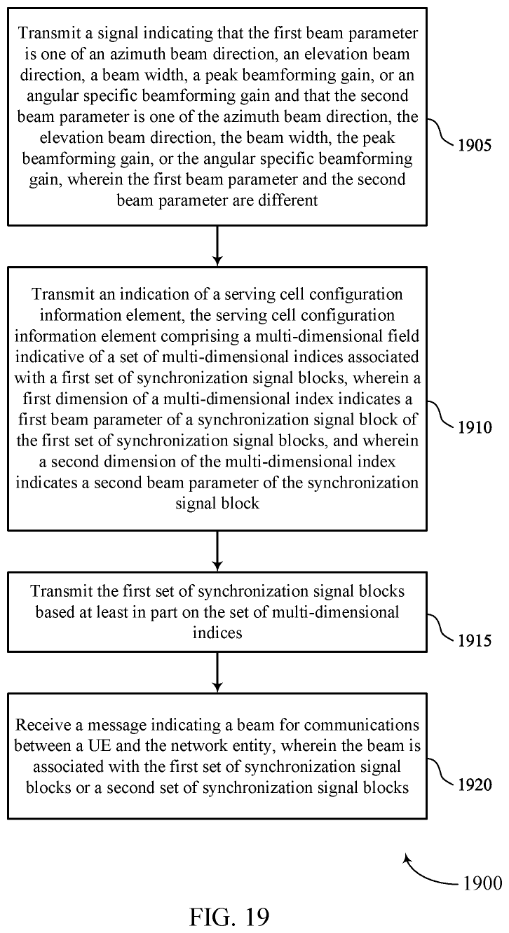

FIG. 19 shows a flowchart illustrating a method 1900 that supports techniques for indicating parameters associated with an SSB in accordance with one or more aspects of the present disclosure. The operations of the method 1900 may be implemented by a network entity or its components as described herein. For example, the operations of the method 1900 may be performed by a network entity as described with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 1905, the method may include transmitting a signal indicating that the first beam parameter is one of an azimuth beam direction, an elevation beam direction, a beam width, a peak beamforming gain, or an angular specific beamforming gain and that the second beam parameter is one of the azimuth beam direction, the elevation beam direction, the beam width, the peak beamforming gain, or the angular specific beamforming gain, where the first beam parameter and the second beam parameter are different. The operations of 1905 may be performed in accordance with examples as disclosed herein. In some examples, aspects of the operations of 1905 may be performed by a multi-dimensional index definition component 1445 as described with reference to FIG. 14.

At 1910, the method may include transmitting an indication of a serving cell configuration information element, the serving cell configuration information element including a multi-dimensional field indicative of a set of multi-dimensional indices associated with a first set of SSBs, where a first dimension of a multi-dimensional index indicates a first beam parameter of an SSB of the first set of SSBs, and where a second dimension of the multi-dimensional index indicates a second beam parameter of the SSB. The operations of 1910 may be performed in accordance with examples as disclosed herein. In some examples, aspects of the operations of 1910 may be performed by a multi-dimensional index component 1425 as described with reference to FIG. 14.

At 1915, the method may include transmitting the first set of SSBs based on the set of multi-dimensional indices. The operations of 1915 may be performed in accordance with examples as disclosed herein. In some examples, aspects of the operations of 1915 may be performed by an SSB transmission component 1430 as described with reference to FIG. 14.

At 1920, the method may include receiving a message indicating a beam for communications between a UE and the network entity, where the beam is associated with the first set of SSBs or a second set of SSBs. The operations of 1920 may be performed in accordance with examples as disclosed herein. In some examples, aspects of the operations of 1920 may be performed by a beam indication component 1435 as described with reference to FIG. 14.

The following provides an overview of aspects of the present disclosure:

Aspect 1: A method for wireless communications at a UE, comprising: receiving an indication of a serving cell configuration information element, the serving cell configuration information element comprising a multi-dimensional field indicative of a set of multi-dimensional indices associated with a first set of synchronization signal blocks, wherein a first dimension of a multi-dimensional index indicates a first beam parameter of a synchronization signal block of the first set of synchronization signal blocks, and wherein a second dimension of the multi-dimensional index indicates a second beam parameter of the synchronization signal block; receiving the first set of synchronization signal blocks based at least in part on the set of multi-dimensional indices; predicting one or more measurements associated with a second set of synchronization signal blocks based at least in part on the first beam parameter, the second beam parameter, and one or more measurements associated with the received first set of synchronization signal blocks; and transmitting a message indicating a beam for communications between the UE and a network entity based at least in part on the one or more measurements associated with the first set of synchronization signal blocks and the predicted one or more measurements associated with the second set of synchronization signal blocks.

Aspect 2: The method of aspect 1, wherein receiving the indication comprises: receiving a radio resource control message comprising the serving cell configuration information element.

Aspect 3: The method of any of aspects 1 through 2, wherein receiving the indication comprises: receiving remaining minimum system information (RMSI) indicating the set of multi-dimensional indices.

Aspect 4: The method of any of aspects 1 through 3, wherein receiving the indication comprises: receiving other system information (OSI) indicating the set of multi-dimensional indices.

Aspect 5: The method of any of aspects 1 through 4, wherein receiving the indication comprises: receiving a signal comprising a first integer associated with the first dimension and a second integer associated with the second dimension of the multi-dimensional index for each synchronization signal block of the first set of synchronization signal blocks.

Aspect 6: The method of aspect 5, further comprising: mapping each synchronization signal block of the first set of synchronization signal blocks to a multi-dimensional index table based at least in part on the first integer and the second integer corresponding to each synchronization signal block.

Aspect 7: The method of aspect 6, wherein the first integer indicates a column of the multi-dimensional index table and the second integer indicates a row of the multi-dimensional index table.

Aspect 8: The method of any of aspects 5 through 7, further comprising: receiving an indication of a maximum integer associated with the first dimension and a maximum integer associated with the second dimension.

Aspect 9: The method of any of aspects 5 through 8, wherein a maximum integer associated with the first dimension is predefined and a maximum integer associated with the second dimension is predefined.

Aspect 10: The method of any of aspects 5 through 9, wherein the first integer is less than or equal to a maximum integer associated with the first dimension and the second integer is less than or equal to a maximum integer associated with the second dimension.

Aspect 11: The method of any of aspects 1 through 10, wherein receiving the indication comprises: receiving a signal comprising a first integer indicative of a size of the first dimension and a second integer indicative of a size of the second dimension; and mapping, sequentially, each synchronization signal block of the first set of synchronization signal blocks to locations of a multi-dimensional index table based at least in part on the first integer and the second integer and an order of synchronization signal blocks of the first set of synchronization signal blocks.

Aspect 12: The method of aspect 11, further comprising: receiving an indication of an integer range associated with the first dimension and an integer range associated with the second dimension, the first integer being within the integer range associated with the first dimension and the second integer being within the integer range associated with the second dimension, wherein the integer range associated with the first dimension, the second dimension, or both is defined by a minimum integer and a maximum integer.

Aspect 13: The method of any of aspects 11 through 12, wherein the first integer defines a number of columns of the multi-dimensional index table and the second integer defines a number of rows of the multi-dimensional index table.

Aspect 14: The method of any of aspects 1 through 13, further comprising: receiving a signal indicating that the first beam parameter is one of an azimuth beam direction, an elevation beam direction, a beam width, a peak beamforming gain, or an angular specific beamforming gain and that the second beam parameter is one of the azimuth beam direction, the elevation beam direction, the beam width, the peak beamforming gain, or the angular specific beamforming gain, wherein the first beam parameter and the second beam parameter are different.

Aspect 15: The method of any of aspects 1 through 14, further comprising: identifying that the first beam parameter is one of an azimuth beam direction, an elevation beam direction, a beam width, a peak beamforming gain, or an angular specific beamforming gain based at least in part on a preconfiguration of the first beam parameter; and identifying that the second beam parameter is one of the azimuth beam direction, the elevation beam direction, the beam width, the peak beamforming gain, or the angular specific beamforming gain based at least in part on a preconfiguration of the second beam parameter, wherein the first beam parameter and the second beam parameter are different.

Aspect 16: The method of any of aspects 1 through 15, wherein predicting the one or more measurements comprises: inputting the first beam parameter, the second beam parameter, and one or more measurements associated with the received first set of synchronization signal blocks to a beam prediction model; and identifying the one or more measurements associated with the second set of synchronization signal blocks as outputs of the beam prediction model.

Aspect 17: The method of claim 16, wherein the beam prediction model is an algorithm, or a machine-learning model.

Aspect 18: The method of any of aspects 1 through 17, wherein a second set of multi-dimensional indices are associated with a first set of channel state information reference signals, a first dimension of a second multi-dimensional index indicates a first beam parameter of a channel state information reference signal of the first set of channel state information reference signals, and a second dimension of the second multi-dimensional index indicates a second beam parameter of the channel state information reference signal of the first set of channel state information reference signals.

Aspect 19: The method of aspect 18, further comprising: receiving the first set of channel state information reference signals based at least in part on the second set of multi-dimensional indices; predicting one or more measurements associated with a second set of channel state information reference signals based at least in part on the first beam parameter of the channel state information reference signal, the second beam parameter of the channel state information reference signal, and one or more measurements associated with the received first set of channel state information reference signals; and transmitting a second message indicating channel information associated with communications between the UE and the network entity based at least in part on the one or more measurements associated with the first set of channel state information reference signals and the predicted one or more measurements associated with the second set of channel state information reference signals.

Aspect 20: A method for wireless communications at a network entity, comprising: transmitting an indication of a serving cell configuration information element, the serving cell configuration information element comprising a multi-dimensional field indicative of a set of multi-dimensional indices associated with a first set of synchronization signal blocks, wherein a first dimension of a multi-dimensional index indicates a first beam parameter of a synchronization signal block of the first set of synchronization signal blocks, and wherein a second dimension of the multi-dimensional index indicates a second beam parameter of the synchronization signal block; transmitting the first set of synchronization signal blocks based at least in part on the set of multi-dimensional indices; and receiving a message indicating a beam for communications between a UE and the network entity, wherein the beam is associated with the first set of synchronization signal blocks or a second set of synchronization signal blocks.

Aspect 21: The method of aspect 20, wherein transmitting the indication further comprises: transmitting a radio resource control message comprising the serving cell configuration information element.

Aspect 22: The method of any of aspects 20 through 21, wherein transmitting the indication comprises: transmitting remaining minimum system information (RMSI) indicating the set of multi-dimensional indices.

Aspect 23: The method of any of aspects 20 through 22, wherein transmitting the indication comprises: transmitting other system information (OSI) indicating the set of multi-dimensional indices.

Aspect 24: The method of any of aspects 20 through 23, wherein transmitting the indication comprises: transmitting a signal comprising a first integer associated with the first dimension and a second integer associated with the second dimension of the multi-dimensional index for each synchronization signal block of the first set of synchronization signal blocks.

Aspect 25: The method of aspect 24, wherein each synchronization signal block of the first set of synchronization signal blocks is mappable to a multi-dimensional index table based at least in part on the first integer and the second integer corresponding to each synchronization signal block.

Aspect 26: The method of aspect 25, wherein the first integer indicates a column of the multi-dimensional index table and the second integer indicates a row of the multi-dimensional index table.

Aspect 27: The method of any of aspects 24 through 26, further comprising: transmitting an indication of a maximum integer associated with the first dimension and a maximum integer associated with the second dimension.

Aspect 28: The method of any of aspects 24 through 27, wherein a maximum integer associated with the first dimension is predefined and a maximum integer associated with the second dimension is predefined.

Aspect 29: The method of any of aspects 24 through 28, wherein the first integer is less than or equal to a maximum integer associated with the first dimension and the second integer is less than or equal to a maximum integer associated with the second dimension.

Aspect 30: The method of any of aspects 20 through 29, wherein transmitting the indication further comprises: transmitting a signal comprising a first integer indicative of a size of the first dimension and a second integer indicative of a size of the second dimension, wherein each synchronization signal block of the first set of synchronization signal blocks is mappable, sequentially, to locations of a multi-dimensional index table based at least in part on the first integer and the second integer and an order of synchronization signal blocks of the first set of synchronization signal blocks.

Aspect 31: The method of aspect 30, further comprising: transmitting an indication of an integer range associated with the first dimension and an integer range associated with the second dimension, the first integer being within the integer range associated with the first dimension and the second integer being within the integer range associated with the second dimension, wherein the integer range associated with the first dimension, the second dimension, or both is defined by a minimum integer and a maximum integer.

Aspect 32: The method of any of aspects 30 through 31, wherein the first integer defines a number of columns of the multi-dimensional index table and the second integer defines a number of rows of the multi-dimensional index table.

Aspect 33: The method of any of aspects 20 through 32, further comprising: transmitting a signal indicating that the first beam parameter is one of an azimuth beam direction, an elevation beam direction, a beam width, a peak beamforming gain, or an angular specific beamforming gain and that the second beam parameter is one of the azimuth beam direction, the elevation beam direction, the beam width, the peak beamforming gain, or the angular specific beamforming gain, wherein the first beam parameter and the second beam parameter are different.

Aspect 34: The method of any of aspects 20 through 33, wherein a second set of multi-dimensional indices are associated with a first set of channel state information reference signals, a first dimension of a second multi-dimensional index indicates a first beam parameter of a channel state information reference signal of the first set of channel state information reference signals, and a second dimension of the second multi-dimensional index indicates a second beam parameter of the channel state information reference signal of the first set of channel state information reference signals.

Aspect 35: The method of aspect 34, further comprising: transmitting the first set of channel state information reference signals based at least in part on the second set of multi-dimensional indices; and receiving a message indicating channel information associated with communications between the UE and a network entity, wherein the channel information is associated with the first set of channel state information reference signals, a second set of channel state information reference signals, or both.

Aspect 36: An apparatus for wireless communications at a UE, comprising a processor; memory coupled with the processor; and instructions stored in the memory and executable by the processor to cause the apparatus to perform a method of any of aspects 1 through 19.

Aspect 37: An apparatus for wireless communications at a UE, comprising at least one means for performing a method of any of aspects 1 through 19.

Aspect 38: A non-transitory computer-readable medium storing code for wireless communications at a UE, the code comprising instructions executable by a processor to perform a method of any of aspects 1 through 19.

Aspect 39: An apparatus for wireless communications at a network entity, comprising a processor; memory coupled with the processor; and instructions stored in the memory and executable by the processor to cause the apparatus to perform a method of any of aspects 20 through 35.

Aspect 40: An apparatus for wireless communications at a network entity, comprising at least one means for performing a method of any of aspects 20 through 35.

Aspect 41: A non-transitory computer-readable medium storing code for wireless communications at a network entity, the code comprising instructions executable by a processor to perform a method of any of aspects 20 through 35

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
a memory; and
a processor coupled to the memory and configured to:
receive an indication of a serving cell configuration information element, the serving cell configuration information element comprising a multi-dimensional field indicative of a set of multi-dimensional indices associated with a first set of synchronization signal blocks, wherein a first dimension of a multi-dimensional index indicates a first beam parameter of a synchronization signal block of the first set of synchronization signal blocks, and wherein a second dimension of the multi-dimensional index indicates a second beam parameter of the synchronization signal block;
receive the first set of synchronization signal blocks based at least in part on the set of multi-dimensional indices;
predict one or more measurements associated with a second set of synchronization signal blocks based at least in part on the first beam parameter, the second beam parameter, and one or more measurements associated with the received first set of synchronization signal blocks; and
transmit a message indicating a beam for communications between the UE and a network entity based at least in part on the one or more measurements associated with the first set of synchronization signal blocks and the predicted one or more measurements associated with the second set of synchronization signal blocks.

2. The apparatus of claim 1, wherein the processor configured to receive the indication is configured to:
receive a radio resource control message comprising the serving cell configuration information element.

3. The apparatus of claim 1, wherein the processor configured to receive the indication is configured to:
receive remaining minimum system information (RMSI) indicating the set of multi-dimensional indices.

4. The apparatus of claim 1, wherein the processor configured to receive the indication is configured to:
receive other system information (OSI) indicating the set of multi-dimensional indices.

5. The apparatus of claim 1, wherein the processor configured to receive the indication is configured to:
receive a signal comprising a first integer associated with the first dimension and a second integer associated with the second dimension of the multi-dimensional index for each synchronization signal block of the first set of synchronization signal blocks.

6. The apparatus of claim 5, wherein the processor is further configured to:
map each synchronization signal block of the first set of synchronization signal blocks to a multi-dimensional index table based at least in part on the first integer and the second integer corresponding to each synchronization signal block.

7. The apparatus of claim 6, wherein the first integer indicates a column of the multi-dimensional index table and the second integer indicates a row of the multi-dimensional index table.

8. The apparatus of claim 5, wherein the processor is further configured to:
receive an indication of a maximum integer associated with the first dimension and a maximum integer associated with the second dimension.

9. The apparatus of claim 5, wherein a maximum integer associated with the first dimension is predefined and a maximum integer associated with the second dimension is predefined.

10. The apparatus of claim 5, wherein the first integer is less than or equal to a maximum integer associated with the first dimension and the second integer is less than or equal to a maximum integer associated with the second dimension.

11. The apparatus of claim 1, wherein the processor configured to receive the indication is configured to:
receive a signal comprising a first integer indicative of a size of the first dimension and a second integer indicative of a size of the second dimension; and
mapping, sequentially, each synchronization signal block of the first set of synchronization signal blocks to locations of a multi-dimensional index table based at least in part on the first integer and the second integer and an order of synchronization signal blocks of the first set of synchronization signal blocks.

12. The apparatus of claim 11, wherein the processor is further configured to:
receive an indication of an integer range associated with the first dimension and an integer range associated with the second dimension, the first integer being within the integer range associated with the first dimension and the second integer being within the integer range associated with the second dimension, wherein the integer range associated with the first dimension, the second dimension, or both is defined by a minimum integer and a maximum integer.

13. The apparatus of claim 11, wherein the first integer defines a number of columns of the multi-dimensional index table and the second integer defines a number of rows of the multi-dimensional index table.

14. The apparatus of claim 1, wherein the processor is further configured to:
receive a signal indicating that the first beam parameter is one of an azimuth beam direction, an elevation beam direction, a beam width, a peak beamforming gain, or an angular specific beamforming gain and that the second beam parameter is one of the azimuth beam direction, the elevation beam direction, the beam width, the peak beamforming gain, or the angular specific beamforming gain, wherein the first beam parameter and the second beam parameter are different.

15. The apparatus of claim 1, wherein the processor is further configured to:
identify that the first beam parameter is one of an azimuth beam direction, an elevation beam direction, a beam width, a peak beamforming gain, or an angular specific beamforming gain based at least in part on a preconfiguration of the first beam parameter; and
identify that the second beam parameter is one of the azimuth beam direction, the elevation beam direction, the beam width, the peak beamforming gain, or the angular specific beamforming gain based at least in part on a preconfiguration of the second beam parameter, wherein the first beam parameter and the second beam parameter are different.

16. The apparatus of claim 1, wherein the processor configured to predict the one or more measurements is configured to:
input the first beam parameter, the second beam parameter, and the one or more measurements associated with the received first set of synchronization signal blocks to a beam prediction model; and
identify the one or more measurements associated with the second set of synchronization signal blocks as outputs of the beam prediction model.

17. The apparatus of claim 16, wherein the beam prediction model is an algorithm or a machine learning model.

18. The apparatus of claim 1, wherein:
a second set of multi-dimensional indices are associated with a first set of channel state information reference signals,
a first dimension of a second multi-dimensional index indicates a first beam parameter of a channel state information reference signal of the first set of channel state information reference signals, and
a second dimension of the second multi-dimensional index indicates a second beam parameter of the channel state information reference signal of the first set of channel state information reference signals.

19. The apparatus of claim 18, wherein the processor is further configured to:
receive the first set of channel state information reference signals based at least in part on the second set of multi-dimensional indices;
predict one or more measurements associated with a second set of channel state information reference signals based at least in part on the first beam parameter of the channel state information reference signal, the second beam parameter of the channel state information reference signal, and one or more measurements associated with the received first set of channel state information reference signals; and
transmit a second message indicating channel information associated with communications between the UE and the network entity based at least in part on the one or more measurements associated with the first set of channel state information reference signals and the predicted one or more measurements associated with the second set of channel state information reference signals.

20. A method for wireless communications at a user equipment (UE), comprising:
receiving an indication of a serving cell configuration information element, the serving cell configuration information element comprising a multi-dimensional field indicative of a set of multi-dimensional indices associated with a first set of synchronization signal blocks, wherein a first dimension of a multi-dimensional index indicates a first beam parameter of a synchronization signal block of the first set of synchronization signal blocks, and wherein a second dimension of the multi-dimensional index indicates a second beam parameter of the synchronization signal block;
receiving the first set of synchronization signal blocks based at least in part on the set of multi-dimensional indices;
predicting one or more measurements associated with a second set of synchronization signal blocks based at least in part on the first beam parameter, the second beam parameter, and one or more measurements associated with the received first set of synchronization signal blocks; and
transmitting a message indicating a beam for communications between the UE and a network entity based at least in part on the one or more measurements associated with the first set of synchronization signal blocks and the predicted one or more measurements associated with the second set of synchronization signal blocks.

21. The method of claim 20, wherein receiving the indication comprises:
receiving a radio resource control message comprising the serving cell configuration information element.

22. The method of claim 20, wherein receiving the indication comprises:
receiving remaining minimum system information (RMSI) indicating the set of multi-dimensional indices.

23. The method of claim 20, wherein receiving the indication comprises:
receiving other system information (OSI) indicating the set of multi-dimensional indices.

24. The method of claim 20, wherein receiving the indication comprises:
receiving a signal comprising a first integer associated with the first dimension and a second integer associated with the second dimension of the multi-dimensional index for each synchronization signal block of the first set of synchronization signal blocks.

25. The method of claim 24, further comprising:
mapping each synchronization signal block of the first set of synchronization signal blocks to a multi-dimensional index table based at least in part on the first integer and the second integer corresponding to each synchronization signal block.

26. The method of claim 20, wherein receiving the indication comprises:
receiving a signal comprising a first integer indicative of a size of the first dimension and a second integer indicative of a size of the second dimension; and
mapping, sequentially, each synchronization signal block of the first set of synchronization signal blocks to locations of a multi-dimensional index table based at least in part on the first integer and the second integer and an order of synchronization signal blocks of the first set of synchronization signal blocks.

27. The method of claim 20, further comprising:
receiving a signal indicating that the first beam parameter is one of an azimuth beam direction, an elevation beam direction, a beam width, a peak beamforming gain, or an angular specific beamforming gain and that the second beam parameter is one of the azimuth beam direction, the elevation beam direction, the beam width, the peak beamforming gain, or the angular specific beamforming gain, wherein the first beam parameter and the second beam parameter are different.

28. The method of claim 20, wherein predicting the one or more measurements comprises:
inputting the first beam parameter, the second beam parameter, and the one or more measurements associated with the received first set of synchronization signal blocks to a beam prediction model; and
identifying the one or more measurements associated with the second set of synchronization signal blocks as outputs of the beam prediction model.

29. An apparatus for wireless communications at a user equipment (UE), comprising:
means for receiving an indication of a serving cell configuration information element, the serving cell configuration information element comprising a multi-dimensional field indicative of a set of multi-dimensional indices associated with a first set of synchronization signal blocks, wherein a first dimension of a multi-dimensional index indicates a first beam parameter of a synchronization signal block of the first set of synchronization signal blocks, and wherein a second dimension of the multi-dimensional index indicates a second beam parameter of the synchronization signal block;
means for receiving the first set of synchronization signal blocks based at least in part on the set of multi-dimensional indices;
means for predicting one or more measurements associated with a second set of synchronization signal blocks based at least in part on the first beam parameter, the second beam parameter, and one or more measurements associated with the received first set of synchronization signal blocks; and
means for transmitting a message indicating a beam for communications between the UE and a network entity based at least in part on the one or more measurements associated with the first set of synchronization signal blocks and the predicted one or more measurements associated with the second set of synchronization signal blocks.

30. A non-transitory computer-readable medium storing code for wireless communications at a user equipment (UE), the code comprising instructions executable by a processor to:
receive an indication of a serving cell configuration information element, the serving cell configuration information element comprising a multi-dimensional field indicative of a set of multi-dimensional indices associated with a first set of synchronization signal blocks, wherein a first dimension of a multi-dimensional index indicates a first beam parameter of a synchronization signal block of the first set of synchronization signal blocks, and wherein a second dimension of the multi-dimensional index indicates a second beam parameter of the synchronization signal block;
receive the first set of synchronization signal blocks based at least in part on the set of multi-dimensional indices;
predict one or more measurements associated with a second set of synchronization signal blocks based at least in part on the first beam parameter, the second beam parameter, and one or more measurements associated with the received first set of synchronization signal blocks; and
transmit a message indicating a beam for communications between the UE and a network entity based at least in part on the one or more measurements associated with the first set of synchronization signal blocks and the predicted one or more measurements associated with the second set of synchronization signal blocks.
